(19) United States
(12) Patent Application Publication
(10) Pub. No.: US 2014/0297468 A1
(43) Pub. Date: Oct. 2, 2014

(54) Consumer Contractor Connector Apparatuses, Methods and Systems

(71) Applicant: Fraser Patterson, New York, NY (US)

(72) Inventor: Fraser Patterson, New York, NY (US)

(21) Appl. No.: 14/227,980

(22) Filed: Mar. 27, 2014

Related U.S. Application Data
(60) Provisional application No. 61/805,928, filed on Mar. 27, 2013.
(60) Provisional application No. 61/806,347, filed on Mar. 28, 2013.
(60) Provisional application No. 61/806,355, filed on Mar. 28, 2013.

(51) Int. Cl. G06Q 30/06

(52) U.S. Cl. CPC G06Q 30/0633; G06Q 30/0609; G06Q 30/0611
USPC 705/26.35

(57) ABSTRACT

Consumer contractor connector apparatuses, methods and systems transform consumer project information, selected items, desired bids, milestones met, milestone payment request, accepted jobs, bid selection, and contractor information inputs via CCC various components into project payment outputs. The CCC may receive consumer project information from the consumer and retrieve contractor profiles to determine at least one contractor that has been prequalified as capable of performing the project and as having obtained a bond commensurate in amount with an estimated project value. The CCC may retrieve a bid from the at least one contractor and retrieve consumer feedback including an accepted bid. Funds can be obtained from the consumer through an escrow account created with the funds. When a milestone is indicated as completed and the consumer accepts that the milestone was properly completed, a determined portion of the funds can be released to the contractor.

### CROSS-REFERENCE TO RELATED APPLICATIONS

This application is related to and claims the benefit of priority under 35 U.S.C. §119(e) of U.S. Provisional Patent Application Ser. No. 61/805,928, titled “Consumer Contractor Connector Apparatuses, Methods and Systems,” filed on Mar. 27, 2013, U.S. Provisional Patent Application Ser. No. 61/806,347, titled “Consumer Contractor Connector Apparatuses, Methods and Systems,” filed on Mar. 28, 2013 and U.S. Provisional Patent Application Ser. No. 61/806,355, titled “Consumer Contractor Connector Apparatuses, Methods and Systems,” filed on Mar. 28, 2013, the disclosures of which are hereby incorporated by reference in their entireties.

### FIELD

The present innovations generally address bridging a gap between contractors and consumers and include consumer contractor connector (CCC) apparatuses, methods and systems directed to connecting contractors and consumers with respect to one or more projects, work orders, jobs or the like. More specifically the present disclosure includes innovations for protecting residential consumers from contractor failures by prequalifying all contractors and ensuring each contractor has adequate bond capacity reserved exclusively for each consumer's project.

### BACKGROUND

Consumers may seek to hire a contractor for various projects. Similarly contractors may seek clients. Consumers may pay contractors for their work on these projects. Inherent in each of these projects is a certain level of risk for both the consumer and the contractor(s) that needs to be managed, mitigated and/or eliminated. Traditionally protection against such risk, which in many cases includes the risk of a contractor not completing a project or completing a project unsatisfactorily, has been addressed by choosing a contractor with a good reputation and/or a contractor that has bond insurance. Bonds shift risk of contractor failure from the consumer to a bonding company, or surety (insurer). If a contractor fails to perform or live up to its responsibilities, the surety can replace the contractor and/or pay the extra costs to complete a project. Surety bonds have conventionally been used for large or complex commercial construction, rather than for homeowner projects in the residential context.

### SUMMARY

Disclosed herein are apparatuses, methods and systems relating to connecting one or more consumers (e.g., one or more homeowners) with one or more contractors (e.g., homebuilders, remodelers, plumbers, electricians and the like) according to the subject matter of the present disclosure. Apparatus and system embodiments of the disclosed subject matter may be referred to herein as a consumer contractor connector (CCC) and may be implemented using one or more method embodiments of the present disclosure. Some embodiments may include a user interface for allowing contractors and consumers to register with a CCC, which can allow the CCC to align or match at least one contractor with at least one consumer based on information provided by the at least one contractor and the at least one consumer. Embodiments of the present disclosure may include the CCC implementing a system for qualifying contractors based on past performance and/or requiring such contractors to be prequalified for a performance bond to ensure completion and/or financial backing for a consumer project. In some embodiments prequalification may be performed by licensed surety and/or insurer.

Some method embodiments disclosed herein include a computer implemented method, which may comprise receiving, from a consumer at a processor, consumer project information corresponding to a consumer project and retrieving contractor profiles. The computer implemented method may include determining, at the processor, at least one suggested contractor from the contractor profiles, wherein the at least one contractor may be capable of performing the consumer project. In some embodiments the at least one contractor may be prequalified by the CCC, including requiring the contractor to obtain a performance bond in an amount commensurate with an estimated value of the consumer project. In some embodiments prequalification by the CCC may involve a licensed surety and/or insurer conducting one or more prequalification processes and/or checks on the contractor. The computer implemented method may include retrieving a bid from the at least one suggested contractor and retrieving consumer feedback on the bid from the at least one suggested contractor, wherein the consumer feedback contains an accepted bid associated with one of the at least one suggested contractors. The computer implemented method may include obtaining funds from the consumer, obtaining an indication of a milestone completion from a selected contractor, obtaining a consumer acceptance that the milestone was properly completed, and releasing a determined portion of the funds to the selected contractor.

Some system embodiments disclosed herein include a system, which may comprise at least one programmable processor and a machine-readable medium storing instructions that, when executed by the at least one programmable processor, may cause the at least one programmable processor to perform operations. The operations may comprise receiving, from a consumer at a processor, consumer project information corresponding to a consumer project and retrieving contractor profiles. The operations may comprise determining, at the processor, at least one suggested contractor from the contractor profiles, wherein the at least one contractor is capable of performing the consumer project. In some embodiments the at least one contractor may be prequalified by the CCC, including requiring the contractor to obtain a performance bond in an amount commensurate with an estimated value of the consumer project. In some embodiments prequalification by the CCC may involve a licensed surety and/or insurer conducting one or more prequalification processes and/or checks on the contractor. The operations may comprise retrieving a bid from the at least one suggested contractor and retrieving consumer feedback on the bid from the at least one suggested contractor, wherein the consumer feedback may contain an accepted bid associated with one of the at least one suggested contractors. The operations may comprise obtaining funds from the consumer, obtaining an indication of a milestone completion from a selected contractor, obtaining a consumer acceptance that the milestone was properly completed, and releasing a determined portion of the funds to the selected contractor.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

These and other aspects will now be described in detail with reference to the following drawings.

FIG. 1 shows a data flow diagram illustrating various embodiments of a CCC according to some aspects of the disclosure.

FIG. 2 illustrates an embodiment of a user interface of a CCC, including input fields for allowing a consumer to enter information into a server, such as for setting up a consumer account and finding a contractor to assist in completing a project, according to some aspects of the disclosure.

FIG. 3 illustrates an embodiment of a user interface showing questions for prompting a consumer to enter information into input fields, such as information relating to a project, according to some aspects of the disclosure.

FIG. 4 illustrates an embodiment of a user interface showing a video that can be played to a consumer for assisting the consumer with using a CCC, according to some aspects of the disclosure.

FIG. 5 illustrates an embodiment of a user interface showing a project outlining tool, which can assist a consumer in defining the project to be completed by at least one contractor, according to some aspects of the disclosure.

FIG. 6 illustrates an embodiment of a user interface showing three contractor bids obtained by a CCC for presenting to a consumer for review, including comparing bids against each other, according to some aspects of the disclosure.

FIG. 7 illustrates an embodiment of a user interface showing an expanded view of three contractor bids obtained by a CCC, according to some aspects of the disclosure.

FIG. 8 illustrates an embodiment of a user interface showing a graphical representation of three contractor bids obtained by a CCC, according to some aspects of the disclosure.

FIG. 9 illustrates an embodiment of a user interface showing an expanded view of a first contractor bid obtained by a CCC, according to some aspects of the disclosure.

FIG. 10 illustrates an embodiment of a user interface showing financial information, including in graphical form, related to a project of a consumer, according to some aspects of the disclosure.

FIG. 11 illustrates an embodiment of a user interface showing a payment confirmation form that allows a consumer to approve, reject and/or comment on one or more tasks a contractor is requesting payment for, according to some aspects of the disclosure.

FIG. 12 illustrates an embodiment of a user interface showing a change order confirmation form that allows a consumer to approve, reject and/or comment on one or more tasks of a change order, according to some aspects of the disclosure.

FIG. 13 illustrates a data flowchart of a method embodiment for matching a consumer with a contractor, managing a project for the consumer and ensuring that payment to a contractor is made for performing at least a portion of work relating to the project, according to some aspects of the disclosure.

FIG. 14 illustrates an embodiment of a user interface showing a dashboard for assisting in matching consumers with contractors, managing projects for consumers, providing payments to contractors, and ensuring contractors sufficiently complete projects for consumers, according to some aspects of the disclosure.

FIG. 15 illustrates an embodiment of a user interface showing a dashboard for assisting in matching consumers with contractors, including contractor referral input fields for accepting consumer information that may assist in generating contractor referrals, according to some aspects of the disclosure.

FIG. 16 illustrates an embodiment of a user interface showing a dashboard for assisting in matching consumers with contractors, including contractor invitation input fields for accepting information for creating contractor invitations for particular contractors, according to some aspects of the disclosure.

FIG. 17 illustrates an embodiment of a user interface showing a dashboard for assisting in matching consumers with contractors, including project guarantee input fields for allowing consumers to purchase project guarantees, according to some aspects of the disclosure.

FIG. 18 shows a block diagram illustrating embodiments of a CCC or CCC controller, according to some aspects of the disclosure.

Like reference symbols in the various drawings indicate like elements.

### DETAILED DESCRIPTION

In some implementations, a CCC may provide a connection between consumers and contractors. A consumer may seek to hire a contractor for a particular job, such as a home remodel, adding an addition to a home, and/or the like. The consumer may seek one or multiple bids. Since many consumers have not experienced this process before, they may quickly become bogged down in terminology, charts, timetables, etc., with which they may not be familiar. If the consumer sought multiple bids, he or she may be faced with bids that are vastly different in scale, money and timetable. This vast disparity in bids can be caused by both consumers' and contractors' disparate levels of expertise and both parties' pricing in different levels and amounts of items to complete a construction milestone (e.g., a consumer says “give me a modern kitchen,” but only some of the contractors are savvy enough to realize it requires a second roof exhaust because of local zoning requirements). Because they may not be familiar with the business, this can be daunting, and determining the differences between the bids may be overwhelming. Many consumers may become confused or frustrated and in fact give up on their remodel or project. Generally, the number of projects for which consumers seek bids is vastly greater than the number of projects that are completed.

Embodiments of a CCC system or method may match contractors with consumers while removing much of the miscommunication, misinformation and mitigating risk for both parties. By facilitating communication between the consumer and contractor, a CCC may remove much of the complexity and facilitate an agreement between the consumer and contractor. By requiring that all contractors be prequalified through the CCC system by one or more licensed sureties or insurers, according to some embodiments, and obtain a performance bond with respect to one or more consumer projects may serve to mitigate, if not eliminate, consumer risk.

For example, in some embodiments, a consumer may indicate to a CCC that he or she wishes to complete a certain project within a specified budget range. That CCC may find contractors willing to complete the project within the budget. In some implementations, this may involve contacting contractors in a consumer's geographic area to request one or more bids. A CCC may add granularity to ensure that a contractor and consumer understand each other's expectations for the budget, the work to be completed, the products to be used, the timetable for each step in the process, etc. In so doing, a CCC can help to avoid any potential misunderstandings between consumers and contractors.

Embodiments of the present disclosure also importantly contemplate prequalifying all contractors identified and offered to a consumer by the CCC. In some embodiments prequalifying a contractor may include requiring such contractor to obtain a performance bond for one or more projects by preparing and submitting an application containing professional and personal information to the CCC for evaluation by one or more licensed sureties or insurers. The performance bond may guarantee that a consumer's project will be completed regardless of any contractor failures. In some embodiments the CCC will initiate and handle procurement of any such performance bond for the contractor and, in some cases, serve as the obligee of such bond. That is the surety may promise the CCC (as the obligee) a certain amount if the contractor fails to meet one or more terms of the contractor's agreement with a consumer.

Embodiments are described herein with reference to consumers and contractors. The term “consumers” is used herein to refer to anyone looking to have a project completed (e.g., a homeowner, business owner, business, etc.). Additionally, the term “contractor” is used herein to refer to anyone, including an entity, looking to complete at least a part of a project (e.g., a homebuilder, plumber, electrician, architects, etc.).

A CCC according to some embodiments of the present disclosure may provide an escrow or payment vehicle. After facilitating a connection between a consumer and one or more contractors, a CCC may also facilitate payments between consumers and contractors. This may provide protection and peace of mind to the consumer, as well as to a contractor. For example, once a consumer and contractor have an agreement, the consumer may place all or some of the money in escrow. In some embodiments the escrow may be managed by or on behalf of a CCC. Some embodiments may involve a CCC paying a contractor when some or all work or tasks relating to a project is complete. In some implementations, the agreement between the consumer and contractor may indicate that payment is to be made as certain milestones of the project are reached. In some embodiments, the contractor may indicate to a CCC that a milestone has been reached, and the CCC may send a verification request to the consumer to ensure that the work has been performed. If the consumer indicates that the milestone has been reached, the CCC may then remit the allotted payment to the contractor. In some implementations, a CCC may ask the consumer if he or she is satisfied with the work the contractor has done up to a milestone, for example, between the time the project started and a first milestone, the time between two consecutive milestones, etc. If the consumer indicates to a CCC that he or she is satisfied and confirms that the work has been completed, the CCC may remit payment. If the consumer indicates that the work is not yet complete or completed but not to the satisfaction of the consumer, the CCC may not remit payment at that time. In some embodiments, a CCC may provide a third party arbitrator to review completed work. The third party may be sent to the location of the work to determine whether the work has been performed as would have been expected in the contract.

By way of example a consumer may indicate that cabinets were not installed as provided in the contract and indicate that the CCC should not yet remit payment for the work. A third party, such as for example another CCC contractor or an arbitrator, may be sent to inspect the cabinets. If the cabinets are not complete or have been installed incorrectly or unsatisfactorily, the third party may indicate that payment should not be remitted until the contractor corrects the problem. If the cabinets are complete and are as indicated in the contract, the third party may discuss with the contractor and consumer to determine what the problem may be. If the cabinets are installed incorrectly or if the contractor is doing a poor job and the consumer wishes to no longer use that contractor, the third party may agree, approve the release of such contractor, and arbitrate any financial misunderstandings that may exist between the consumer and the contractor. As such consumers may be assured that they will receive the quality of work for which they are paying, and, similarly, contractors may be assured that they are paid for doing quality work

At least some embodiments of a CCC may provide a consumer-friendly, web-based solution tailored to a market (e.g., United States financial market) to at least reduce payment and performance risks related to a project between consumers and contractors. Embodiments of a CCC may provide a new construction model that provides one or more of transparency, efficiency and financial protection to all users (i.e., consumers and contractors) involved in a project.

By way of example a CCC may provide a method for risk management regarding professional home remodeling construction projects, including maximizing completion probability (e.g., completion guarantee), cost variances to budget (e.g., budget assurance) and payment risks (e.g., payment guarantee). In some embodiments of the present disclosure risk management may include requiring that each contractor offered to a consumer by the CCC be prequalified as capable of performing the project and/or as having obtained one or more performance bonds commensurate in amount to an estimated value of the consumer's project. Embodiments of a CCC may include controls and risk management logic that can simultaneously optimize desired outcomes of a project owner, contractor and surety. A CCC may facilitate scalability of a business, such as by reducing human-resource requirements, maximizing data capture for decision making, and enabling efficient sales and marketing models. A CCC may provide a level of utility and usability that can promote confidence and trust to its users, such as consumers and contractors.

At least some embodiments of a CCC may capture and organize project information, such as remodeling project information, which can be used to protect projects. For example, a CCC can generate valuable data regarding a project by providing project segmented data, granular task specification, line item level project information (e.g., materials, labor budgets, expenditures, etc.), detailed results and competent level reviews. A CCC can be a governing source of record for project metadata, financial transactions, and legal transactions. In some embodiments, a CCC can provide intuitive, comparative and accountable bids to consumers and can assist in reducing a knowledge gap between consumers and contractors. A user interface dashboard provided by a CCC can provide iterative project scope and bid creation, as well as project management, including project finance and project performance management.

At least some embodiments of a CCC may manage intra-project risk through a data model, policy requirements, process controls and reporting. A CCC may continuously optimize network risk, contractor load, project stability (i.e., expected performance) and financial yield (i.e., net revenue margin). According to some embodiments a CCC may use indicators to proactively assess and manage risk.

At least some embodiments of a CCC may facilitate business scalability through automation of process-critical and resource-intensive tasks, robust information capture, and facilitation of an efficient sales and marketing model. According to some embodiments automation of process-critical and resource-intensive tasks by a CCC can minimize administrative overhead and human resource requirements, as well as eliminate human intervention and human error on process-critical tasks.

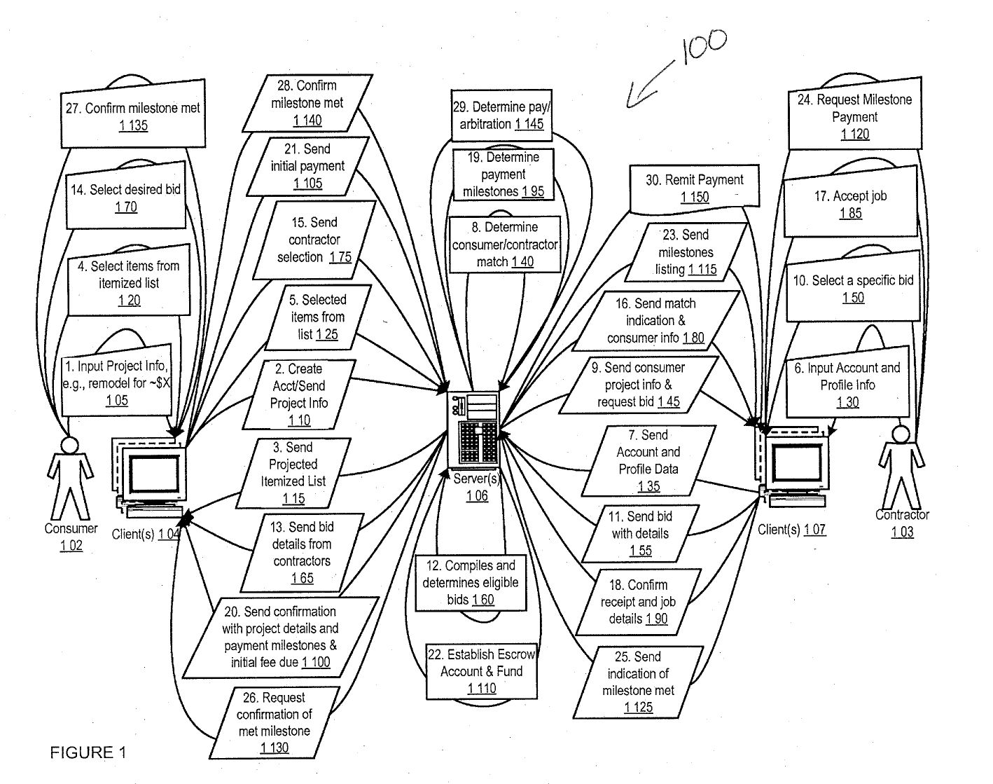

FIG. 1 shows a block diagram illustrating a CCC 100. In some implementations, a consumer 102 may enter project information 105, such as into input fields of a user interface, which can include consumer identification information, project identification information (e.g., “kitchen remodel”), budget information and/or the like. Account and project information 110 may be sent to a server 106, and CCC 100 may send a projected itemized list 115 for consumer 102's project. For example, a kitchen remodel may include tasks such as replacing cabinets and countertops, re-tiling the floor and/or the like. In some implementations, lists may be standardized forms for various types of projects, such as a kitchen remodel form, a bathroom remodel form, a room addition form, and/or the like. Some embodiments may involve lists that are classified by budget ranges, location-specific (such as for zoning laws, regional preferences, etc.) and/or the like. Consumer 102 may select items from a list that he or she would like performed 120. These items may then be sent to a server 125. The server may determine a consumer-contractor match 140. In some embodiments of the present disclosure a consumer-contractor match will include one or more contractors that have been prequalified by the CCC, including requiring that each contractor obtain one or more performance bonds commensurate in amount with an estimated value of the consumer's project. Some embodiments contemplate that the CCC initiate and manage such prequalification in conjunction with one or more bonding companies, sureties and/or insurers and, in some cases, serve as the obligee for the contractor's performance bond. In some embodiments a contractor 103 may have previously created an account my inputting account and profile data 130, and account and profile data may have been sent to the server 135. In some implementations, consumers and contractors may be matched using various criteria and information collected by the consumers and contractors, including location, comparing consumer budget to contractor average project costs, and/or the like.

When a match is identified, server 106 may send (at 145) consumer project information, such as a project outline (i.e., outline of the project, which can include tasks and subtasks for completing the project), to a matched contractor 103 and that contractor 103 may select a bid if he or she is interested in placing a bid on the project. This bid may then be sent to a server 155, which compiles and determines eligible bids 160 for the consumer 102's project. In some implementations, this may include verifying contractor data, such as prices for various items, and ensuring that the quote (i.e., bid) is within the budget supplied by consumer 102. In some embodiments, server 106 may also check that contractor 103 has received good reviews for these types of projects in the past, for example, by checking that a rating is above a certain threshold value. CCC 100 may then send (at 165) contractor 103 bid details to consumer 102, and consumer 102 may view the various bids and select a bid to accept 170. The selection may be sent (at 175) to server 106, which may send a match indication (at 180) to contractor, along with consumer's information. Contractor 103 may then accept a job (at 185), and a confirmation receipt and job details may be sent (at 190) to server 106.

Server 106 may use this information to determine payment milestones 195. In some embodiments, these milestones may be determined after significant parts of a job are completed, for example, after cabinets are installed. In some implementations, milestones may be timed in increments throughout the project, for example, one quarter, halfway, three-quarters and fully through the project, as well as upon full completion. Confirmation may be sent (at 1100) to consumer 102, including project details, payment milestones, and an indication that an initial fee is due. Initial payment may be sent (at 1105) to server 106. Server 106 may establish an escrow account and fund for the project (at 1110). One or more milestone listings may be sent (at 1115) to contractor 103. In some embodiments, the milestone payments may all be received by server 106 before the job begins. In some implementations, payments may be received by an account a specified period before a milestone is scheduled to be completed.

Once a milestone is reached, contactor 103 may request payment (at 1120) and send an indication that the milestone has been met (at 1125). Server 106 may request confirmation from consumer 102 that the milestone has been met (at 1130). Consumer 102 may confirm the milestone was met (at 1135). In some embodiments, consumer 102 may verify completion of the milestone alone, but in other embodiments, consumer (102) may indicate that the milestone was completed unsatisfactorily. Some implementations may allow consumer 102 to indicate a level of satisfaction with the milestone. Confirmation may be sent (at 1140) to server 106 and server 106 may use these indicia to determine if the milestone should be paid or if arbitration may be needed (at 1145). In some implementations, if consumer satisfaction with the milestone is low, or if consumer 102 does not confirm that the milestone has been met, server 106 may indicate that arbitration is needed. If consumer 102 indicates that he or she is satisfied that the milestone has been met, payment for the milestone may be remitted (at 1150) to contractor 103.

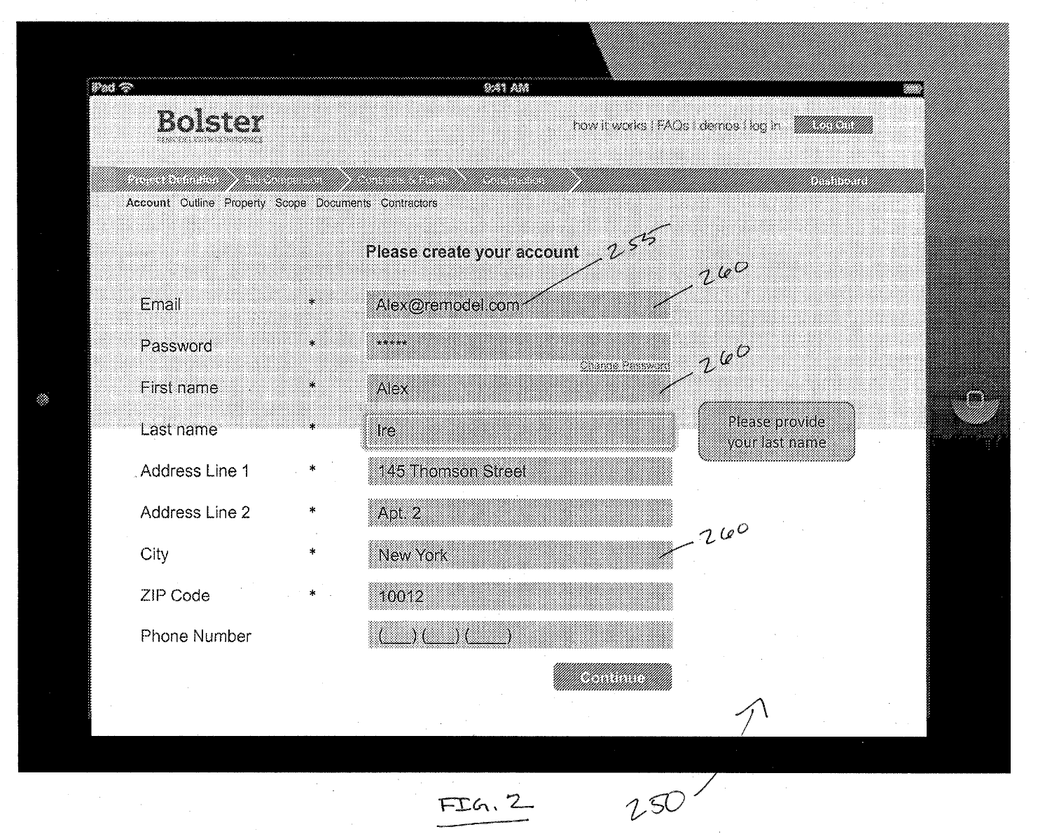

FIG. 2 illustrates an embodiment of a CCC having a user interface 250 that allows a consumer, such as consumer 102 in FIG. 1, to provide consumer information 255 for creating a consumer account. User interface 250 may include input fields 260 that a consumer can enter information into. Consumer information 255 can be collected by the CCC and may include a user name and password that may be used to create and access the consumer account. For example, once a user name and password has been confirmed and saved to a server, such as server 106 in FIG. 1, a consumer may provide additional information that may be stored with the consumer account, such as the consumer's name, physical address, email address, and phone number, as shown for example in FIG. 2.

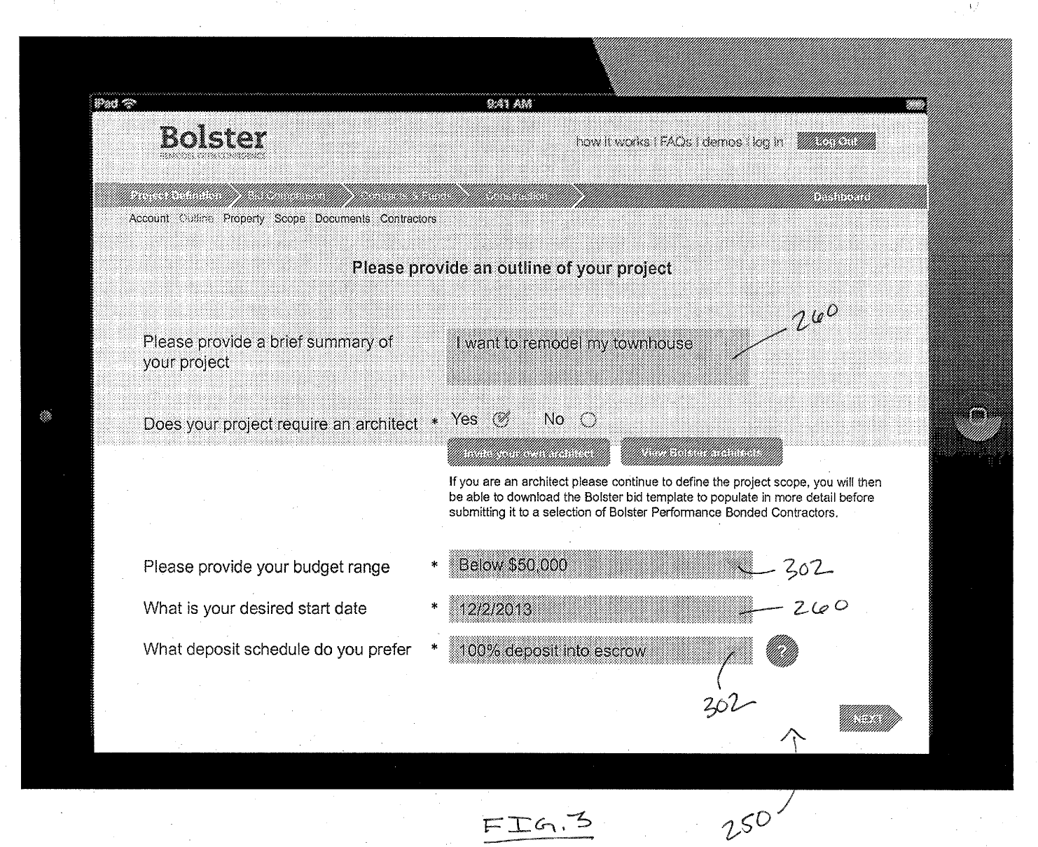

FIG. 3 illustrates an embodiment of a CCC having a user interface 250 that may provide input fields 260, including dropdown menus 302, that allows a consumer to provide the CCC with information regarding a project that the consumer would like completed. User interface 250 may provide questions that the consumer can answer (i.e., enter information in input fields 260) for assisting in constructing a project outline that defines a project the consumer would like completed. The project outline may include a variety of information that assists in defining the project the consumer intends to have completed by a contractor, such as project tasks, scope of project, material costs, labor costs, etc.

For example, to assist the consumer in creating a project outline, user interface 250 may request a brief summary of the project, a budget, a desired start and end date to the construction required to complete the project, and a payment schedule (i.e., when the consumer will submit payment to the contractor). The consumer may indicate on the user interface 250 that the consumer would like to pay for the project in increments, such as upon completion of one or more milestones (e.g., project tasks and/or completion of the project) by the contractor. Alternatively, the consumer may indicate that the consumer would like to pay for the entire project upfront (i.e., deposit the entire project cost into escrow).

User interface 250 may request additional information relating to a project, such as what type of property the project is related to (e.g., commercial property, home, etc.), what type of project is being requested (e.g., gut renovation, conversion, addition, touch up, etc.), and what areas are involved with the project. In some embodiments user interface 250 can provide follow-up questions to previously asked and answered questions. Follow-up questions may define tasks and scope of the project. As such, the CCC may build a detailed project outline of a project desired for completion for the consumer. This detailed project outline may allow a contractor to more efficiently and effectively bid on a project, as well as allow progress and completion of the project to be more easily tracked. The project outline defined by the CCC may also assist in holding parties involved with the project accountable, such as requiring the consumer to pay for agreed upon tasks and for the contractor to complete the agreed upon tasks.

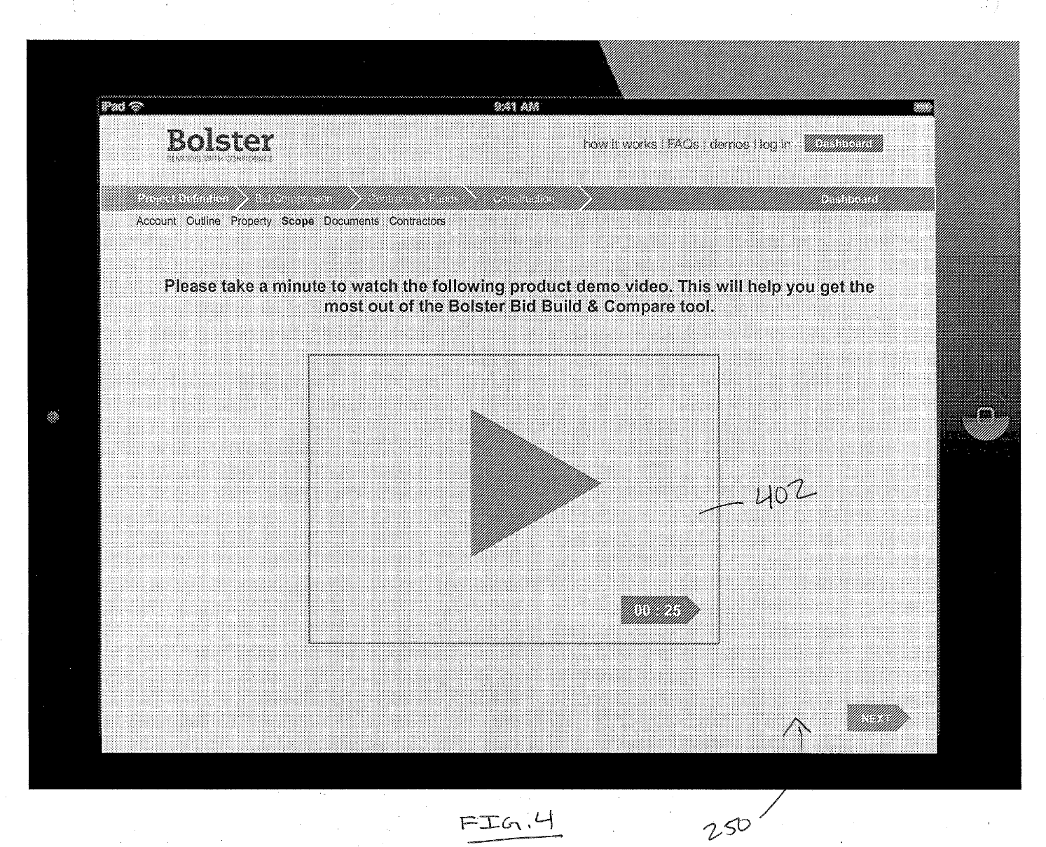

FIG. 4 illustrates an embodiment of a user interface 250 that provides consumers with information and assists consumers with navigating and using a CCC, such as an information video 402 that consumers may view directly from the user interface 250. In some embodiments, user interface 250 may allow consumers to navigate to a help and/or frequently asked questions interface where either consumers or contractors can retrieve assistance and information related to using services provided by the CCC.

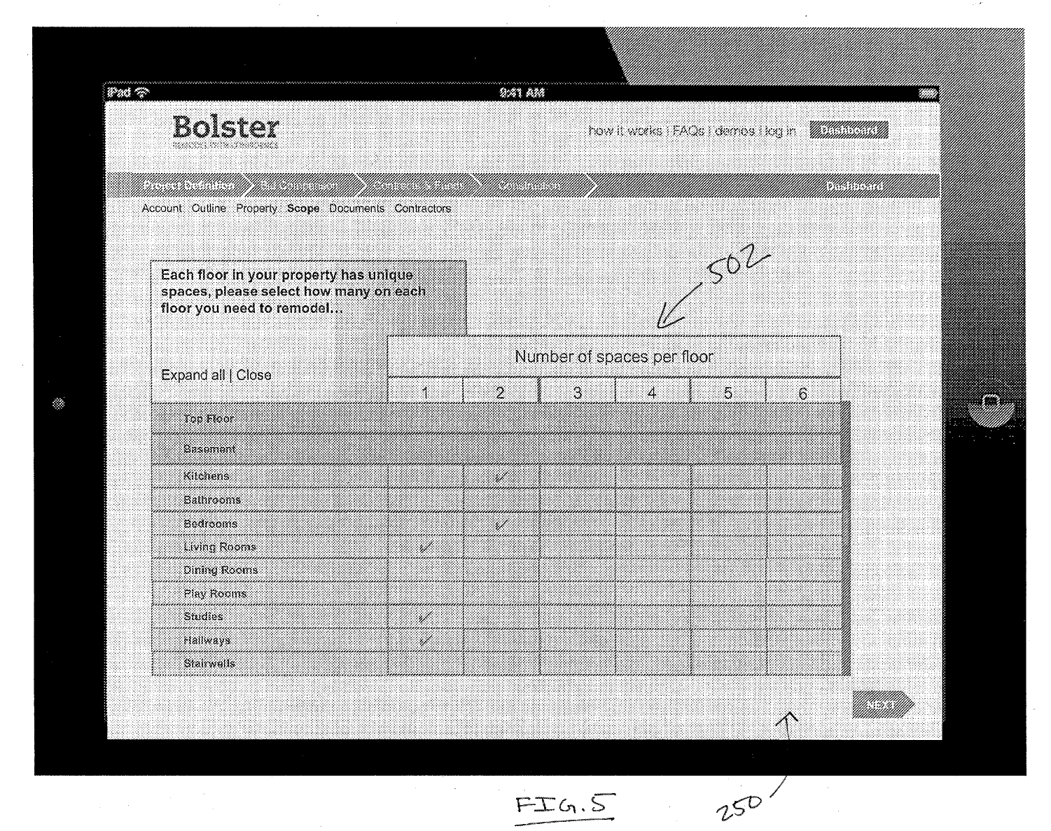

Embodiments of a CCC may provide a variety of ways to assist the consumer in defining a project or project outline. For example, as shown in FIG. 5, some embodiments of a CCC may include providing a project outlining tool 502 that assists in defining scopes and tasks related to a project. The project outlining tool 502 may assist the consumer in defining, for example, a number of spaces (e.g., bathrooms, living rooms, etc.) per floor of a structure, such as a house, the consumer would like the project to include. This can allow bidding contractors to better understand the scope of the project and provide a more accurate bid.

Some CCC embodiments may allow a consumer to upload pictures to a server, which can be sent to potential contractors for assisting with their bidding of the project. Once the CCC has completed acquiring information from a consumer about a project, the CCC can compile information into a project outline and submit the project outline to at least one potential contractor for bidding. The CCC may allow consumers to select one or more contractors to bid on projects. As will be discussed in greater detail below, some embodiments of the present disclosure require that a contractor first register with the CCC prior to receiving a project outline from the CCC for bidding.

CCC embodiments may use a variety of ways to determine which registered contractors to send consumer project outlines to for bidding. For example, the CCC may match one or more information obtained from a consumer with one or more information obtained from registered contractors. For example, the CCC may match a contractor with a consumer based on location information provided by a contractor and consumer.

Once a contractor has received a project outline, the contractor may either accept, reject, or comment on all or parts of the project outline. Comments the contractor provides on the project outline, which may be delivered to and viewed by the consumer, may include, for example, requests for additional information, required or suggested additional tasks for completing the project, and associated costs (i.e., material costs, labor costs, etc.). In some embodiments, if the contractor accepts the project, the contractor may submit a bid for the project to the CCC (i.e., upload the bid to a server), which can include the contractor's comments.

In some embodiments, a CCC can present a consumer with at least one of the collected bids for viewing, such as by inserting the bids into a consumer's account. As mentioned above and discussed in more detail below, embodiments of the present disclosure contemplate that any bidding contractor identified to a consumer by the CCC has been prequalified by the CCC, including requiring that such contractor obtain one or more performance bonds commensurate in amount with an estimated value of the consumer's project. Some embodiments contemplate that the CCC initiate and manage such prequalification in conjunction with one or more bonding companies, sureties and/or insurers and, in some cases, serve as the obligee for such performance bond(s). The consumer may view the bids, including comparing the bids between each other. The bids may also be compared at a detailed level, such as at a task level where each task comprising the project may be analyzed, such as costs relating to each task. This may allow the consumer to identify where cost discrepancies are between the bidding contractors.

Each bid may provide a consumer with detailed information, including comments regarding a contractor's abilities and costs associated with a project. The consumer may include comments, such as in response to comments left by a contractor on a bid, which can be submitted to the contractor. Communication between consumers and contractors can be stored on a server, including any bids or contracts.

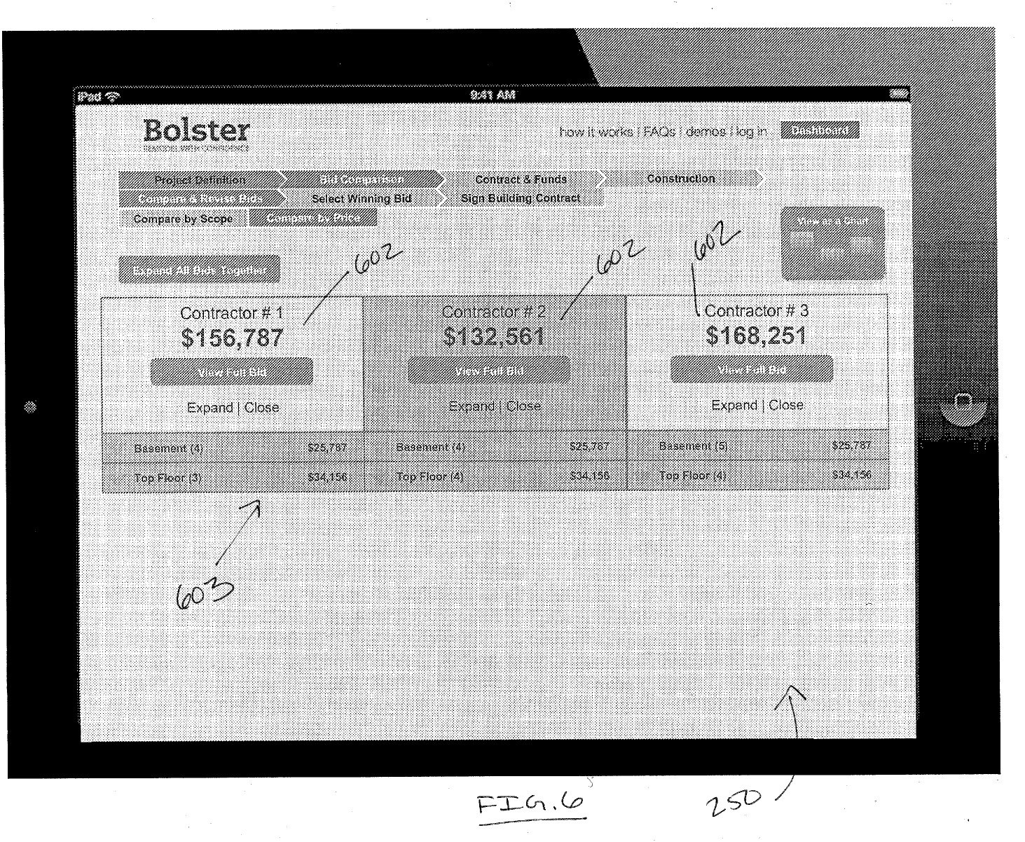

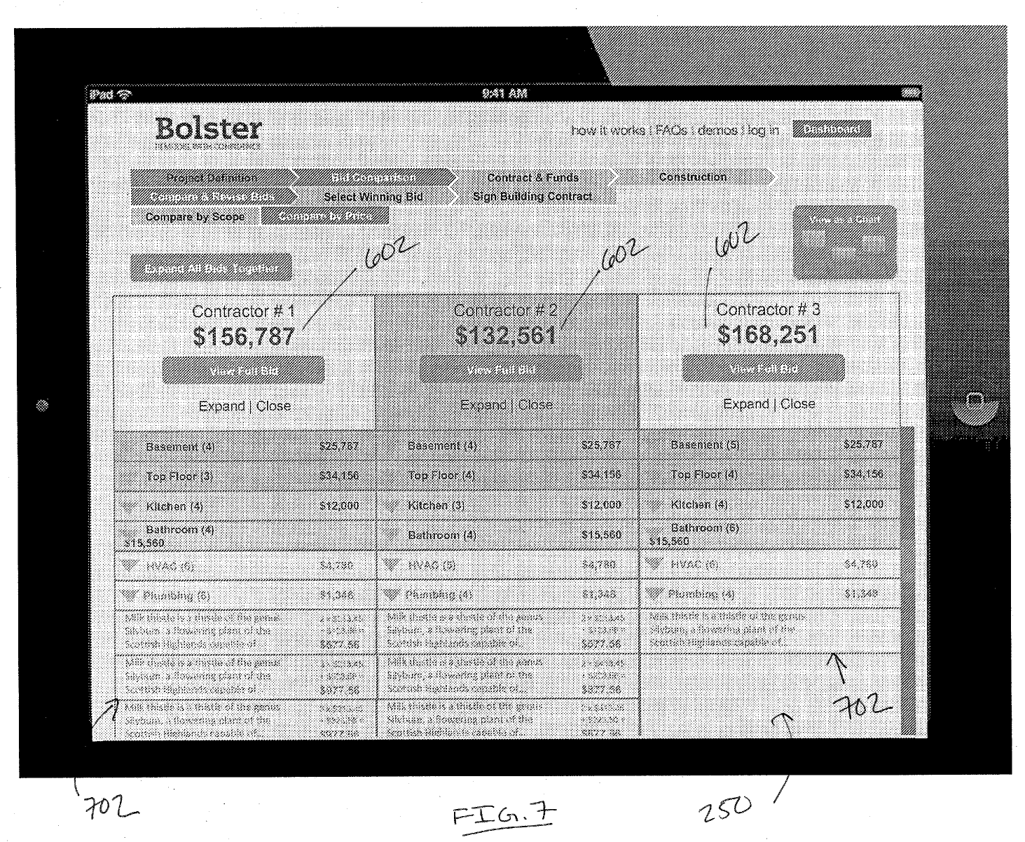

FIG. 6 illustrates an embodiment of user interface 250 showing three contractor bids 602 obtained by a CCC for presenting to a consumer for review, including comparing bids 602 against each other. Information related to each bid can be presented to the consumer in various forms, including in a simplified compact view 603, as shown, for example, in FIG. 6. Information related to each bid 602 can be presented to the consumer in an expanded detailed view 702, as shown, for example, in FIG. 7. In some embodiments, the consumer can select between the simplified compact view 603 and expanded detailed view 702 of one or more bids 602. This can allow the consumer to compare information contained within the bids, such as costs related to project tasks.

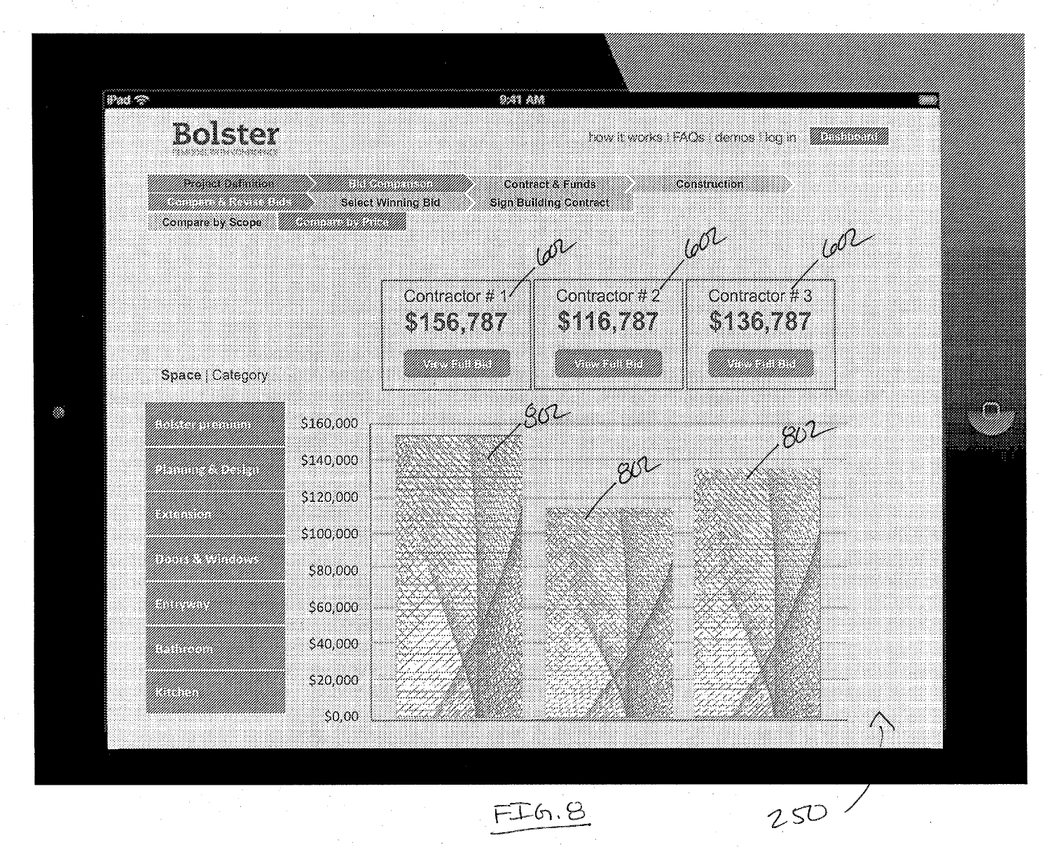

FIG. 8 illustrates an embodiment of a user interface 250 showing a graphical representation 802 of three contractor bids 602 obtained by a CCC. A consumer can select between various views (i.e., expanded detailed view 702, simplified compact view 603, and graphical representation 802) for assisting the consumer with analyzing bids and ultimately selecting a winning bid.

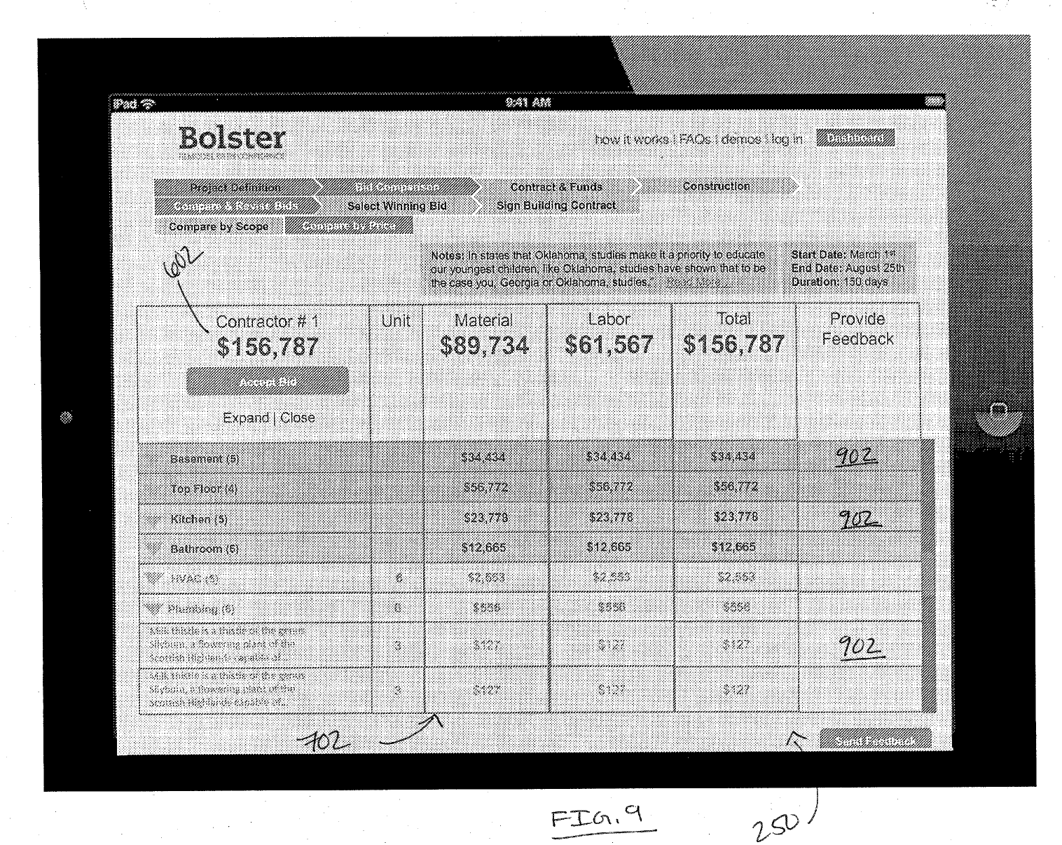

FIG. 9 illustrates an embodiment of a user interface 250 showing an expanded detailed view 702 of a first contractor bid 602 obtained by a CCC. The first contractor bid 602 may also include one or more comment input fields 902 for allowing the consumer to enter comments relating to any line items in the bid, as shown for example in FIG. 9. Comments entered into comment input fields 902 may be submitted to contractors for viewing and responding back to consumers.

A consumer can select a winning bid 602 and enter into a contract with a contractor who submitted the winning bid. For example, the consumer can enter into a contract by submitting a signature (e.g., an electronic signature, including through a web-based service, such as DOCU-SIGN©), or some official authorization. Once a contract is formed between the consumer and contractor, the consumer may be held responsible for paying the contractor for performing work towards the project and the contractor may be held responsible for completing the tasks outlined in the project outline.

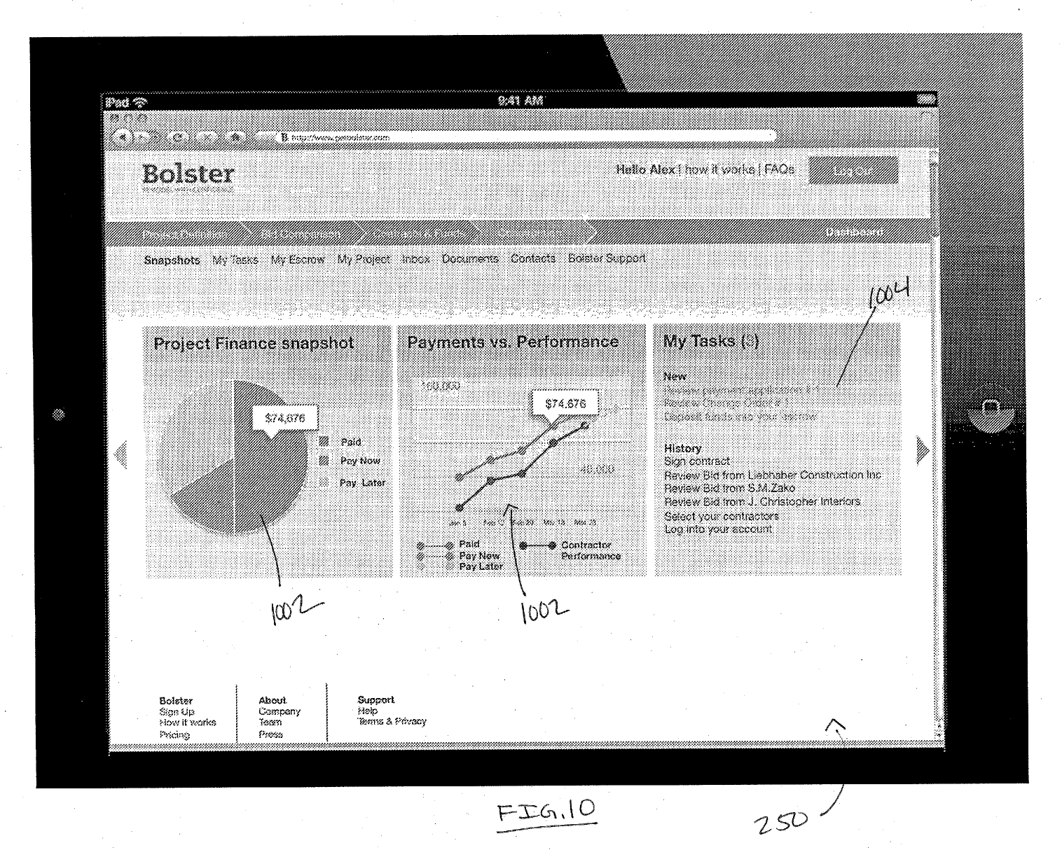

FIG. 10 illustrates an embodiment of a user interface 250 showing financial information, including in graphical form 1002, related to a project of a consumer. The graphical forms 1002 may assist consumers and contractors with evaluating, for example, what tasks have been completed, which tasks need to still be completed, and costs associated with tasks. A CCC can provide a task list 1004 that allows both consumers and contractors to see a list of agreed upon tasks comprising a project, as well as which tasks have been completed and which tasks remain to be completed.

Some embodiments of a CCC can set up an escrow account which may allow a consumer to submit money into the escrow account for holding until a contractor has completed a project or milestone. Upon completion of either the project or milestone, the contractor can request payment, which can be withdrawn from the escrow account.

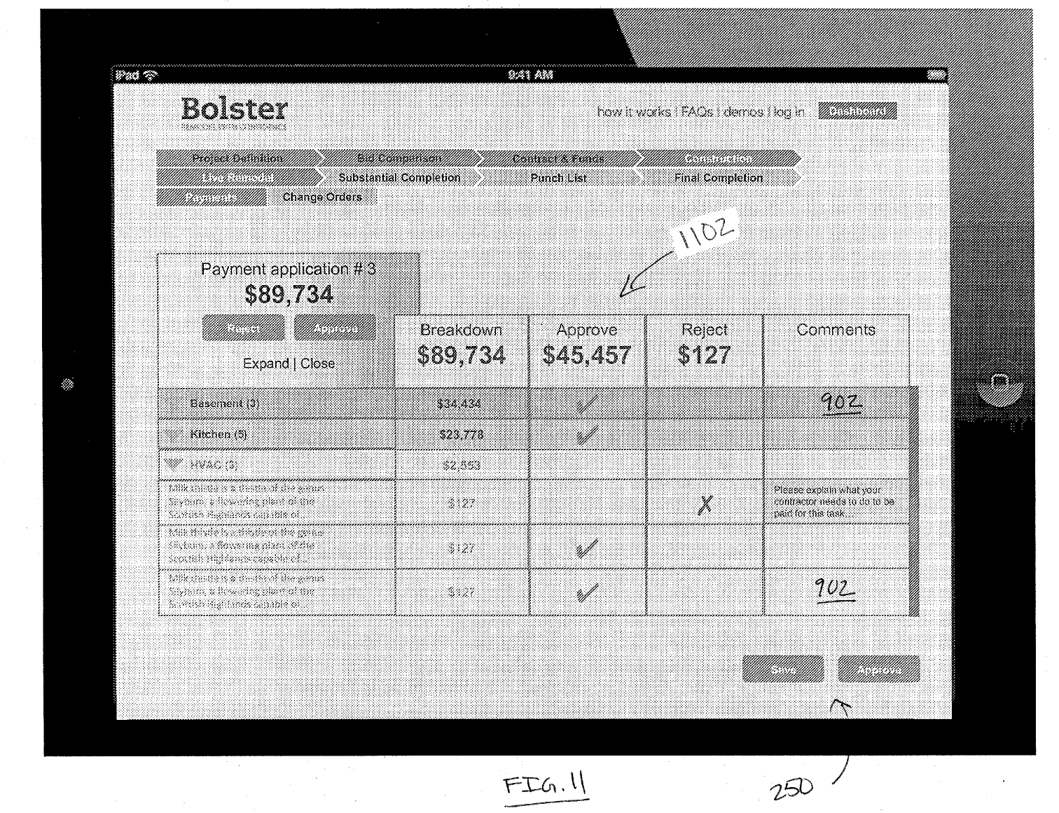

FIG. 11 illustrates an embodiment of a user interface 250 showing a payment confirmation form 1102. The payment confirmation form 1102 can display a breakdown of one or more tasks completed by a contractor for which the contractor would like to be paid for. A consumer may approve, reject and comment on any of the tasks listed in the payment confirmation form 1102. Once payment has been approved by the consumer, a CCC may pay the contractor an approved amount using funds the consumer has placed into an escrow account. If the consumer indicates that the contractor did not sufficiently complete one or more tasks, including the entire project, the CCC may retain funds in the escrow account, such as until a project dispute has been resolved.

Some embodiments of a CCC may provide dispute resolution for assisting disputes between contractors and consumers, such as disputes over quality of work and payment of services. For example, the CCC may provide a mediator to assist in dispute resolution. Additionally, the CCC may provide an arbitrator to assist in dispute resolution, such as for disputes that are unresolved after mediation. The CCC may allow customers and contractors to resolve disputes through the CCC, such as with either a CCC-appointed mediator or arbitrator, which allows the dispute to be resolved with the protection of a performance bond obtained by contractor through a contractor prequalification process instituted by the CCC in conjunction with one or more licensed sureties or insurers.

Resolving disputes through the CCC may result in faster resolutions at a lower cost than through other means (e.g., a civil lawsuit), while also providing assurance that at least the performance bond amount will be available for a winning party. In some embodiments, a CCC can prevent access to the performance bond if either the contractor or consumer chooses to bypass a CCC's dispute resolution options. In some implementations, the CCC may contractually require contractors to resolve disputes through a CCC's dispute resolution options, while still allowing customers an option to use a CCC's dispute resolution options or go through the court system.

Performance bond or other bonds insuring a residential projected, as mentioned above and described herein below in further detail, may be issued to a CCC by a surety, with each contractor as the principal and the CCC as the obligee for the benefit of consumers. With a performance bond, consumers may be guaranteed protection with respect to a project, such as to ensure satisfaction and completion of the project up to a value of a project contract price.

The surety may replace an initial contractor with a replacement contractor in order to complete a project, such as when an initial contractor has failed to complete a project or is not satisfactorily completing the project. In some embodiments, the surety can cover a consumer for additional costs associated with a defaulting contractor, such as up to a contract price of a project. If the customer chooses to bypass a CCC's dispute resolution options, according to some embodiments, the CCC performance bond may no longer apply to the dispute.

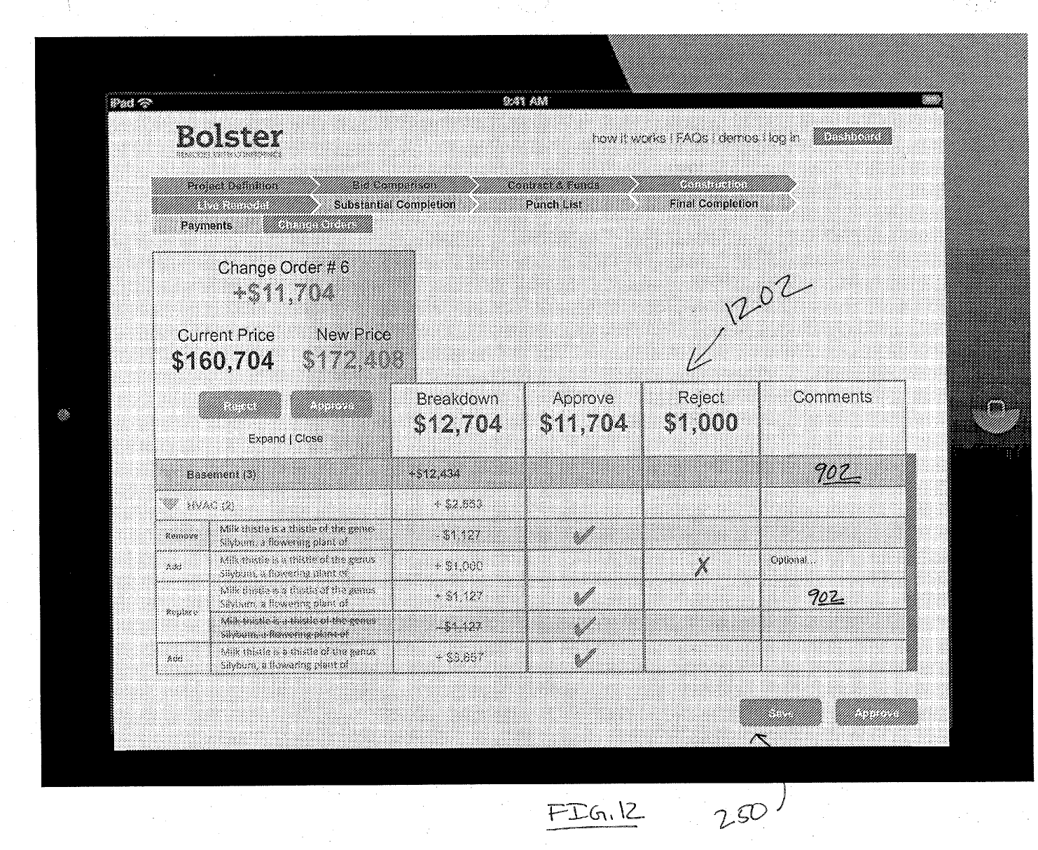

FIG. 12 illustrates an embodiment of a user interface 250 showing a change order confirmation form 1202. The change order confirmation form 1202 can allow either consumers or contractors to approve, reject and/or comment on one or more tasks of the change order confirmation form 1202. For example, a consumer may request additional tasks to be completed (e.g., remodeling to additional rooms, upgrade in construction features or materials, etc.) or to remove one or more tasks outlined in a project contract defining a project.

In some embodiments, if a consumer submits a change order for additional tasks to be completed by a contractor, the contractor may review a change order confirmation form 1202, including accepting, rejecting and commenting on all or part of the change order. If there is a dispute, the CCC may provide dispute resolution options to assist with the change order. Once the change order confirmation form 1202 has been approved by both parties, including any costs associated with the change order, a project contract may be updated to include the changes outlined in the change order. In some embodiments, a CCC may adjust a bond associated with the project according to the change order and may require the consumer to deposit additional funds into the consumer's escrow account, such as to cover additional project tasks added by the change order.

Some embodiments of a CCC may charge consumers a percentage (e.g., approximately 4% to 5%) of the cost of a project. This can allow a free service to contractors.

Some embodiments of a CCC may provide competent reviewers to review work completed by contractors in order to assist in determining quality of work and whether contractors completed a project or task according to a project outline. For example, feedback provided by reviewers may assist in determining whether contractors should be paid by consumers for work completed.

Some embodiments of a CCC may collect and display user or consumer reviews related to contractors who have registered with the CCC. Any number of rating or reviewing systems may be implemented to allow consumers to easily review and identify quality ratings from other consumers related to contractors registered with the CCC.

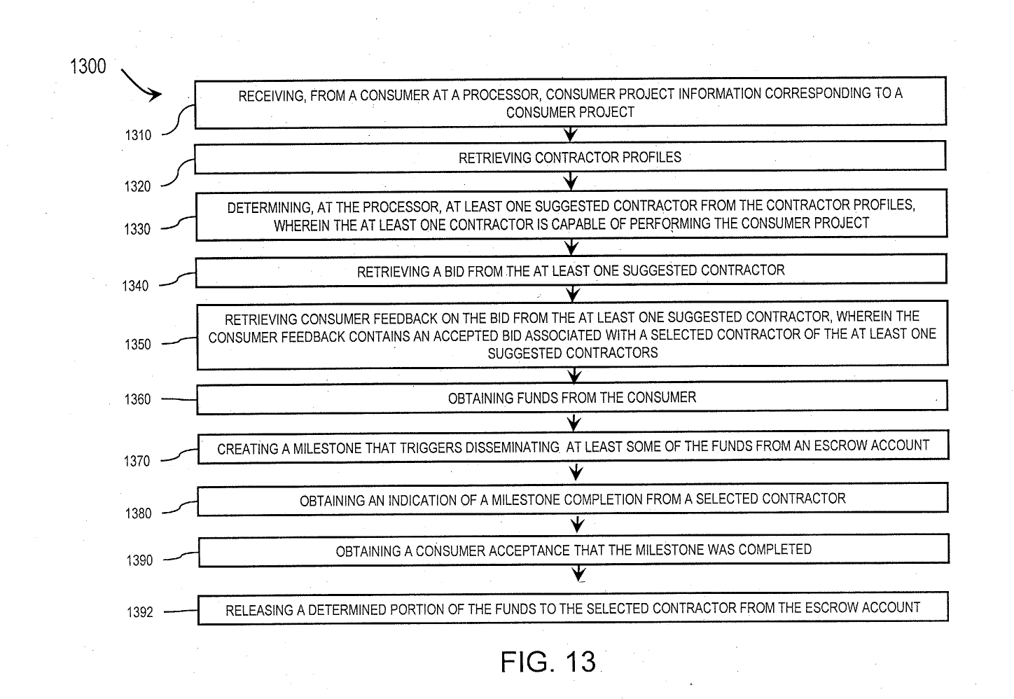

FIG. 13 illustrates a data flowchart 1300 of an embodiment of a CCC. At 1310, a processor of the CCC may receive consumer project information from a consumer corresponding to a consumer project. At 1320, one or more processors associated with the CCC may retrieve contractor profiles. At 1330, at least one suggested contractor from the contractor profiles may be determined by the one or more processors, with at least one contractor capable of performing the project. At 1340, the CCC may retrieve a bid from the at least one suggested contractor. At 1350, the CCC may retrieve consumer feedback on the bid from the at least one suggested contractor, with the consumer feedback containing an accepted bid associated with a selected contractor of the at least one suggested contractors. At 1360, the CCC may obtain funds from the consumer. At 1370, the CCC may create a milestone that triggers disseminating at least some of the funds from an escrow account to the selected contractor. At 1380, the CCC may obtain an indication that the milestone was completed, such as from the selected contractor. At 1390, the CCC may obtain a consumer acceptance that the milestone was properly completed. At 1392, the CCC may release a determined portion of the funds to the selected contractor from the escrow account.

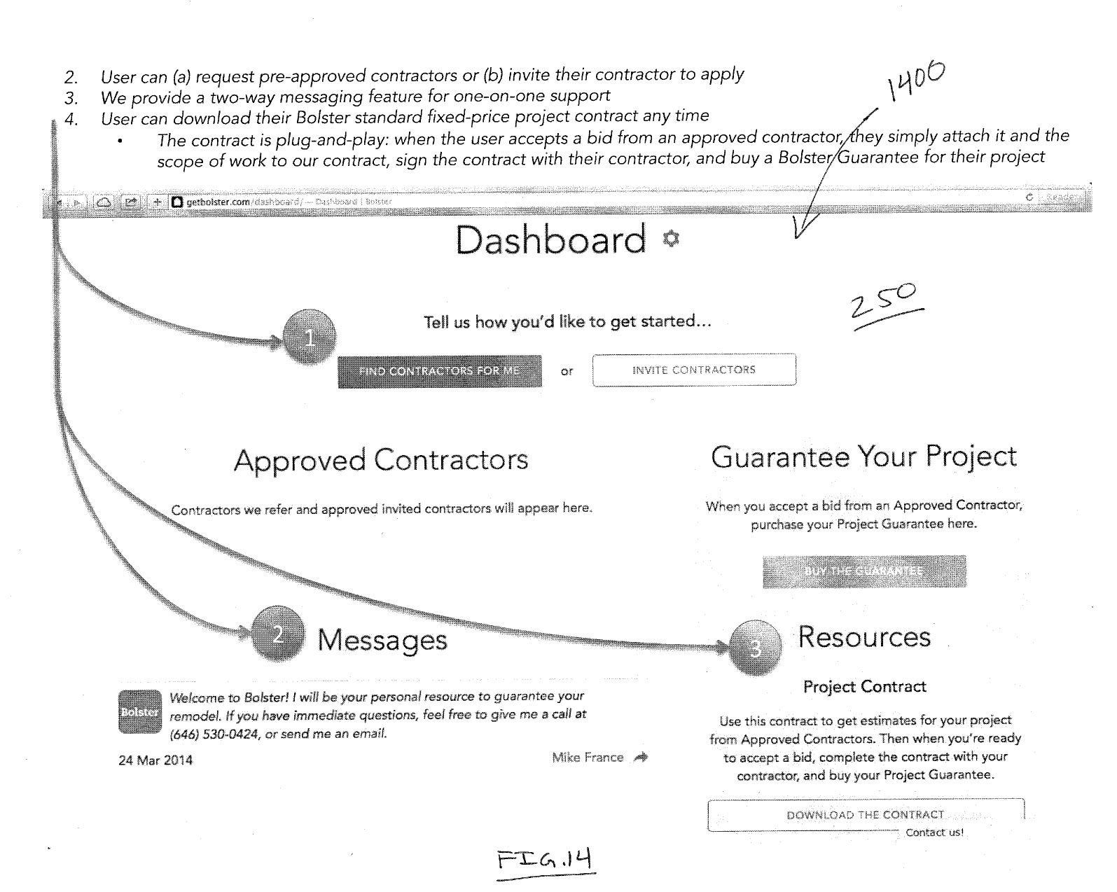

FIG. 14 illustrates an embodiment of a user interface 250 showing a dashboard 1400 that may assist in matching consumers with contractors, managing projects for consumers, providing payments to contractors, and ensuring contractors sufficiently complete projects for consumers. For example, dashboard 1400 may allow consumers to either request pre-approved contractors or invite contractors, such as preferred contractors, to apply for registration with a CCC. Dashboard 1400 may provide a two-way messaging feature, such as between consumers and contractors, as well as one-on-one support for consumers and contractors. Dashboard 1400 may also allow consumers to download a fixed-price contract prepared by the CCC. Fixed-price contracts may be of a plug-and-play form that attaches bids accepted by consumers from approved contractors. A scope of work outlined in the bids may thus be attached to a fixed-price contract, which a consumer may then officially approve, such as with a signature. Consumers may also purchase project guarantees through dashboard 1400.

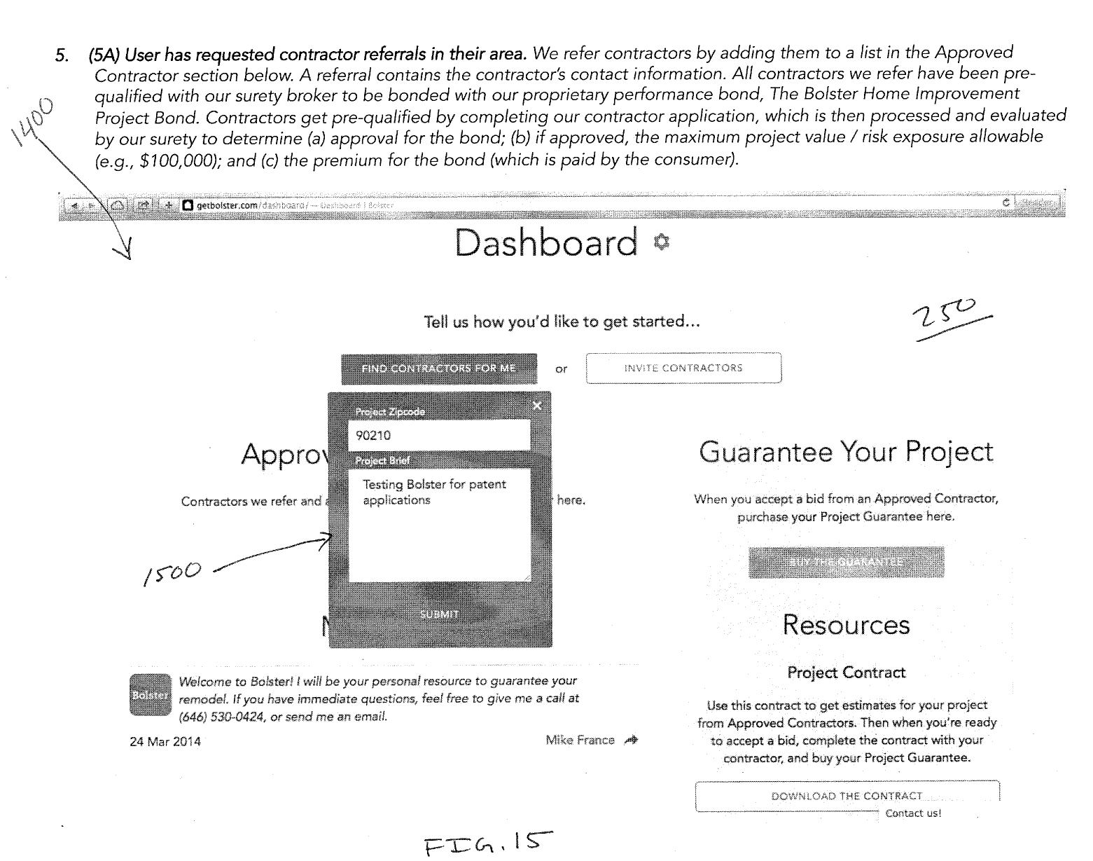

FIG. 15 illustrates an embodiment of a user interface 250 showing a dashboard 1400 for assisting in matching consumers with contractors, including contractor referral input fields 1500 for accepting information that may assist in generating contractor referrals, such as to consumer preferred contractors. The contractor referral input fields 1500 may accept information pertaining to the consumer, such as location (i.e., zip code), in order to assist a CCC with determining suitable suggested contractors, such as contractors that provide services within the consumer's location.

A CCC may refer contractors that have been prequalified with a surety broker to be bonded with a performance bond. Contractors may be pre-approved by completing a CCC registration process, which may include determination if the contractor may be approved for a performance bond. Contractor bonding processes according to the present disclosure may include without limitation one or more of a prequalification sign-up phase, a pre-qualification on tender pack submission phase, a bond application phase, a bond purchase and confirmation phase, a bond renewal phase and/or a change order and bond extensions phase.

Embodiments relating to prequalification signup may involve a contractor filling out and submitted to the CCC an application for a contractor bond. The application may include bond qualification data submitted by a contractor. The CCC may send the application to one or more licensed sureties or insurers. A prequalification check may be carried out by the one or more licensed sureties or insurers to determine, for example, the contractor's expected bond rate. In some embodiments prequalification may involve receiving from a contractor and sending to the one or more licensed sureties or insurers personal information about the contractor. Embodiments of the present disclosure contemplate for lower value projects (e.g., less than $100,000) that prequalification checks by one or more sureties may involve, without limitation, contractor credit score.

Any of the one or more licensed sureties or insurers may provide a response during or following a prequalification check that contains information about the prequalification, including bond amounts, bond rates, collateral requirements and bond duration. Embodiments may involve sending a preapproval message to a contractor that the contractor has been prequalified for a performance bond and, accordingly, has been qualified to be connected to one or more consumers by the CCC. In other embodiments the CCC may receive a response from a surety that the contractor has not been qualified and, accordingly, send a message to the contractor indicating that prequalification has failed, wherein the CCC may assign a new contractor to a consumer's project. In the event that a contractor is approved, the maximum project value and/or risk exposure allowable may be determined. A premium for the performance bond may be paid by a consumer.

Embodiments of the present disclosure may relate to prequalification with a tender pack submission, which may include a contractor submitting an estimate of a project's value as part of a tender pack creation. This estimate may provide indicate how large a required bond should likely to be to adequately protect a consumer's project from contractor failure. In some embodiments a performance bond may be revalidated against the estimated value of a project. If the estimated project value exceeds a prequalification limit then a new bond amount may need to be prequalified. In some embodiments bonding may not be available, wherein the CCC may inform the contractor of their maximum bond amount and allow the contractor to adjust its tender estimate in line with such limit.

A contractor may further confirm the final price for the construction of a project and such price will form the basis of the contractor's bond application. In some embodiments this confirmation may occur at the end of a design phase. To trigger a bond request, embodiments of the present disclosure contemplate the CCC submitting the contractor's full bond application on behalf of the contractor, along with in some cases a payment for the contractor's bond premium, to one or more sureties for processing and/or sending instructions to the contractor on what to expect. Thereafter a bond contract may be presented to the contractor for his signature and the CCC may instruct payment of a bond premium to the surety issuing the bond. A selected surety may confirm to the CCC that the bond is in place and, in turn, the CCC according to some embodiments may confirm to the contractor that such bond is in place.

In some embodiments of the present disclosure one or more surety bonds may pertain to remodeling to protect consumers against contractor failures by shifting risk from consumer to the surety.

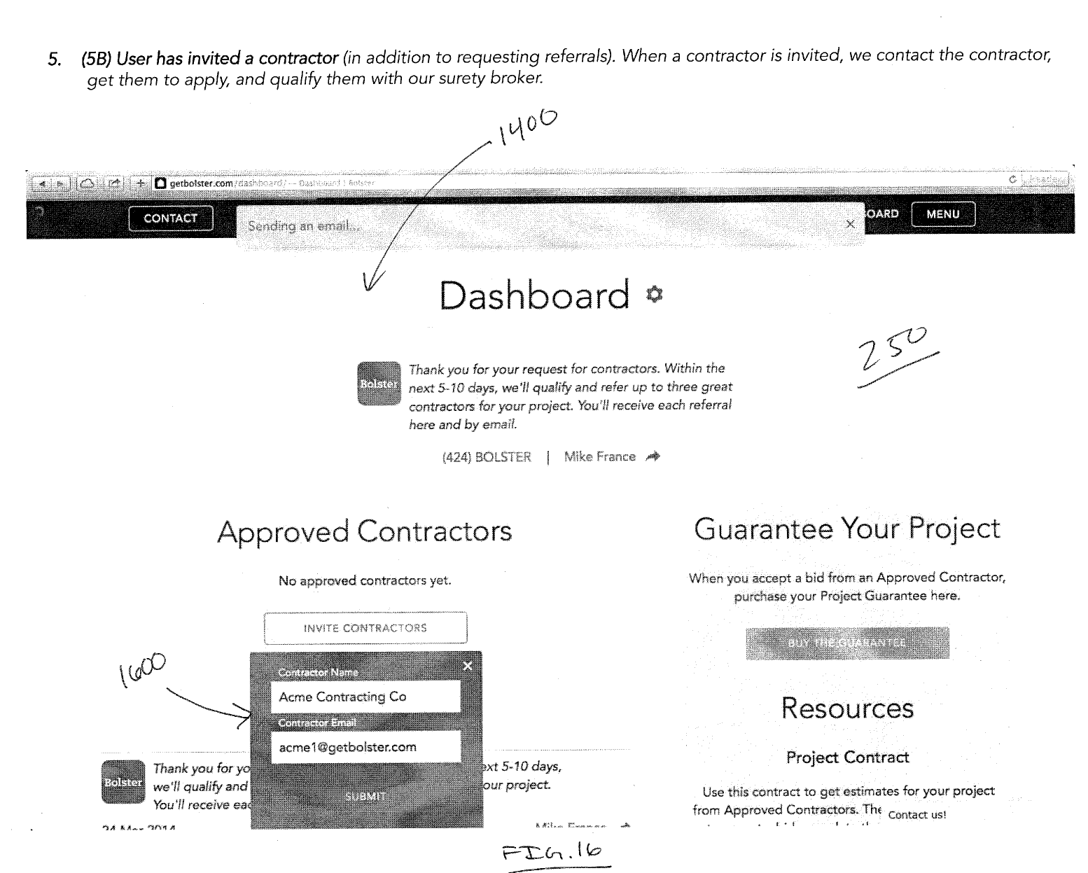

FIG. 16 illustrates an embodiment of a user interface 250 showing a dashboard 1400 for assisting with matching consumers with contractors, including contractor invitation input fields 1600 for accepting information that may assist in generating contractor invitations, such as to consumer preferred contractors.

As discussed above, a contractor can register with a CCC to be eligible to receive customer project outlines from the CCC and submit bids to the CCC in response to received customer project outlines. In some embodiments, the CCC can pre-qualify contractors to determine eligibility for bonding. Bonding of contractors may assist the CCC with providing financial assurance to consumers who contract with contractors registered with the CCC. If, for example, a consumer would like to use a particular contractor who has not pre-registered with the CCC, the non-registered contractor may go through the registration process in order to be able to contract through the CCC.

A CCC may provide contractor registration forms, either electronically or hard copies, which may allow contractors to submit their information to the CCC. Information provided by contractors when registering may include geographic areas contractors provide services, specialties, project types, budget ranges, work history and personal information (i.e., social security numbers, etc.). In some embodiments, the CCC may require contractors to provide various tax and licensing information (e.g., W9 form, EPA lead-safe-certificate, valid home improvement contractor license, valid home improvement sales person license, workers compensation insurance, general liability insurance, etc.).

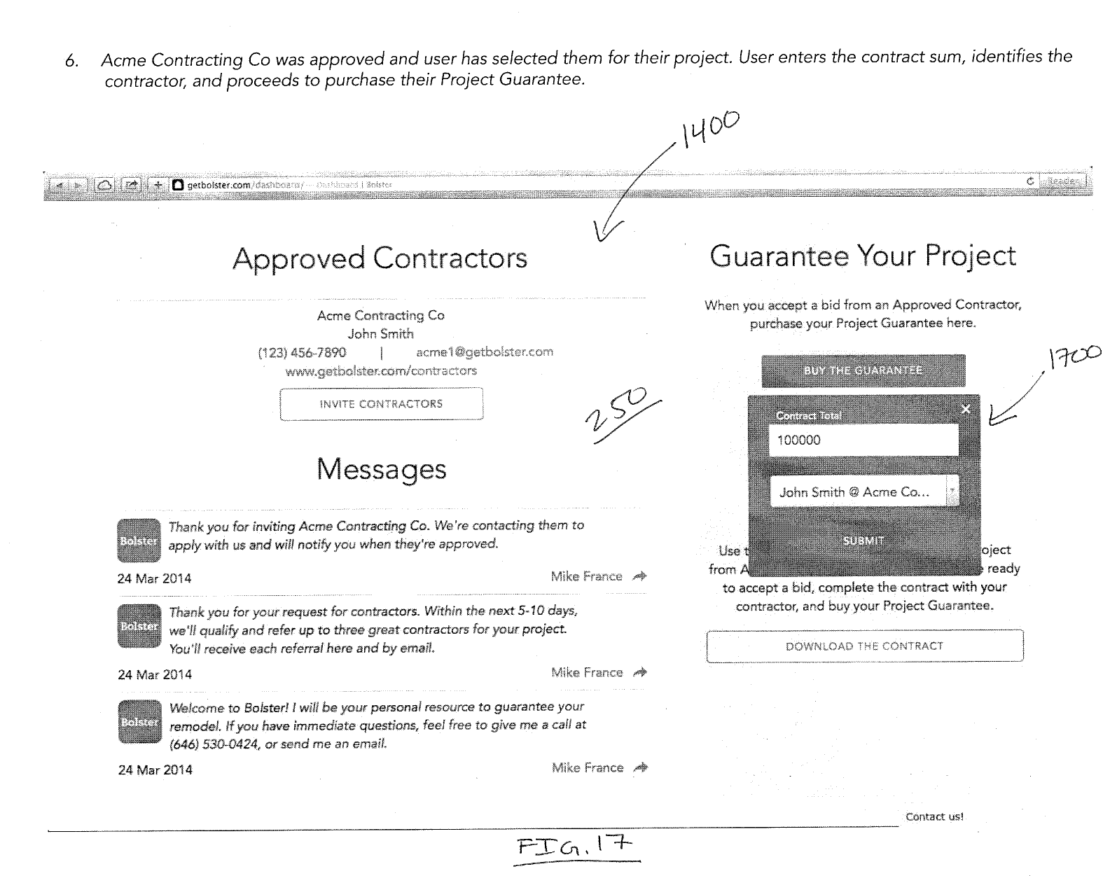

FIG. 17 illustrates an embodiment of a user interface 250 showing a dashboard 1400 for assisting in matching consumers with contractors, including project guarantee input fields 1700 for allowing consumers to purchase project guarantees for a project. A contract total amount may be used to determine and purchase a project guarantee.

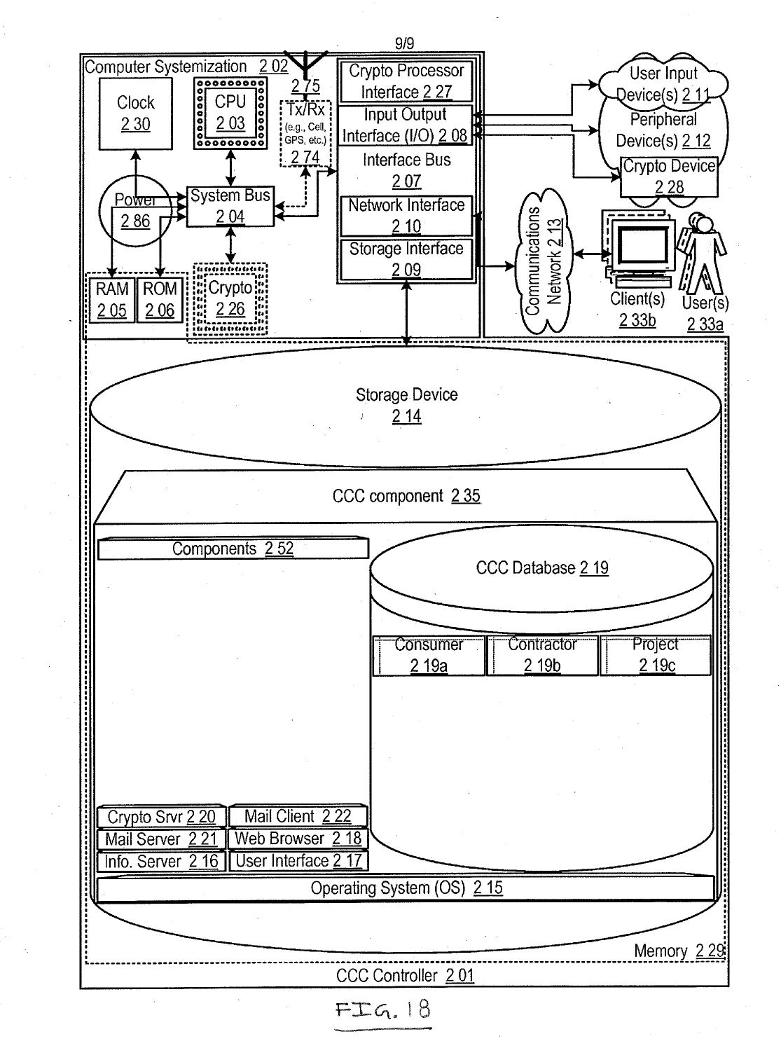

FIG. 18 shows a block diagram illustrating embodiments of a CCC controller 201. In some embodiments, controller 201 may serve to aggregate, process, store, search, serve, identify, instruct, generate, match, and/or facilitate interactions with a computer through consumer contractor connection technologies, and/or other related data.

Typically, users (e.g., consumers and contractors), which may be people and/or other systems, may engage information technology systems (e.g., computers) to facilitate information processing. In turn, computers employ processors to process information; such processors 203 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 229 (e.g., registers, cache memory, random access memory, etc.). Such communicative input/output (IO) instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In some embodiments, controller 201 may be connected to and/or communicate with entities such as, but not limited to, one or more users from user input devices 211, peripheral devices 212, a cryptographic processor device 228 and/or a communications network 213.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network and, in some embodiments, includes software. Servers serve their information to requesting “clients.” The term “client” as used herein refers generally to a computer, program, other device, user and/or combination thereof that is capable of processing and making requests and obtaining and processing any responses from servers across a communications network and, in some embodiments, includes software. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

Controller 201 may be based on computer systems that may comprise, but are not limited to, components such as a computer systemization 202 connected to memory 229.

Computer systemization 202 may comprise a clock 230, central processing unit (“CPU(s)” and/or “processor(s)” (these terms are used interchangeable throughout the disclosure unless noted to the contrary)) 203, a memory 229 (e.g., a read only memory (ROM) 206, a random access memory (RAM) 205, etc.), and/or an interface bus 207, and most frequently, although not necessarily, are all interconnected and/or communicating through a system bus 204 on one or more (mother)board(s) 202 having conductive and/or otherwise transportive circuit pathways through which instructions (e.g., binary encoded signals) may travel to effectuate communications, operations, storage, etc. The computer systemization may be connected to a power source 286, which in some embodiments may be internal. A cryptographic processor 226 and/or transceivers (e.g., ICs) 274 may be connected to the system bus. In some embodiments, the cryptographic processor and/or transceivers may be connected as either internal and/or external peripheral devices 212 via the interface bus I/O. Transceivers may be connected to antenna(s) 275, thereby effectuating wireless transmission and reception of various communication and/or sensor protocols. In some embodiments, antenna(s) may connect to a Texas Instruments WiLink WL1283 transceiver chip (e.g., providing 802.11n, Bluetooth 3.0, FM, global positioning system (GPS) (thereby allowing CCC controller to determine its location)), Broadcom BCM₄₃₂₉FKUBG transceiver chip (e.g., providing 802.1 in, Bluetooth 2.1+EDR, FM, etc.), a Broadcom BCM475oIUB8 receiver chip (e.g., GPS), an Infineon Technologies X-Gold 618-PMB9800 (e.g., providing 2G/3G HSDPA/HSUPA communications) and/or the like.

The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to integrated system (bus) controllers, memory management control units, floating point units, and even specialized processing sub-units like graphics processing units, digital signal processing units, and/or the like. Processors may include internal fast access addressable memory, and be capable of mapping and addressing memory 229 beyond the processor itself. Internal memory may include, but is not limited to, fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor, including without limitation, AMD's Athlon, Duron and/or Opteron, ARM's application, embedded and secure processors, IBM and/or Motorola's DragonBall and PowerPC, IBM's and Sony's Cell processor, Intel's Celeron, Core (2) Duo, Itanium, Pentium, Xeon, and/or XScale, or any other suitable processor(s).

The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the CCC controller and beyond through various interfaces. Should processing requirements dictate a greater amount speed and/or capacity, distributed processors (e.g., Distributed CCC), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of a CCC may be achieved by implementing a microcontroller such as CAST's R8051XC2 microcontroller, Intel's MCS 51 (i.e., 8051 microcontroller) or any other suitable microcontroller(s). To implement certain features of a CCC, some feature implementations may rely on embedded components, such as Application-Specific Integrated Circuit (“ASIC”), Digital Signal Processing (“DSP”), Field Programmable Gate Array (“FPGA”) or other suitable embedded technology. For example, any CCC components (distributed or otherwise) and/or features may be implemented via the microprocessor and/or via embedded components; e.g., via ASIC, coprocessor, DSP, FPGA, and/or the like. Some implementations of a CCC may be implemented with embedded components that are configured and used to achieve a variety of features or signal processing.

Depending on the particular implementation, the embedded components may include software solutions, hardware solutions, and/or some combination of both hardware/software solutions. For example, CCC features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the CCC features. A hierarchy of programmable interconnects allow logic blocks to be interconnected as needed by a CCC system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-22 flops or more complete blocks of memory. In some circumstances, a CCC apparatus or system may be developed on regular FPGAs and then migrated into a fixed version that more resembles ASIC implementations. Some implementations may migrate CCC controller features to a final ASIC instead of or in addition to FPGAs. Depending on the implementation of the aforementioned embedded components and microprocessors may be considered the “CPU” and/or “processor” for a CCC.

The power source 286 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 286 is connected to at least one of the interconnected subsequent components of the CCC thereby providing an electric current to all subsequent components. In one example, the power source 286 is connected to the system bus component 204. In an alternative embodiment, an outside power source 286 is provided through a connection across the I/O 208 interface. For example, a USB and/or IEEE 1394 connection carries both data and power across the connection and is therefore a suitable source of power.

Interface bus(ses) 207 may accept, connect, and/or communicate to a number of interface adapters, conventionally although not necessarily in the form of adapter cards, such as but not limited to: input output interfaces (I/O) 208, storage interfaces 209, network interfaces 210, and/or the like. Cryptographic processor interfaces 227 may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 209 may accept, communicate, and/or connect to a number of storage devices such as, but not limited to, storage devices 214, removable disc devices, and/or the like. Storage interfaces may employ connection protocols such as, but not limited to, (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 210 may accept, communicate, and/or connect to a communications network 213. Through a communications network 213, controller 201 is accessible through remote clients 233b (e.g., computers with web browsers) by users 233a. Network interfaces may employ connection protocols such as, but not limited to direct connect, Ethernet (thick, thin, twisted pair 1o/10o/10oo Base T, and/or the like), Token Ring, wireless connection such as IEEE 8o2.11a-x, and/or the like. Should processing requirements dictate a greater amount speed and/or capacity, distributed network controllers (e.g., Distributed CCC), architectures may similarly be employed to pool, load balance, and/or otherwise increase the communicative bandwidth required by the CCC controller. A communications network may be any one and/or the combination of a direct interconnection, the Internet, a Local Area Network (LAN), a Metropolitan Area Network (MAN), an Operating Missions as Nodes on the Internet (OMNI), a secured custom connection, a Wide Area Network (WAN), a wireless network (e.g., employing protocols such as, but not limited to a Wireless Application Protocol (WAP), I-mode, and/or the like), or any other suitable communications network. A network interface may be regarded as a specialized form of an input output interface. Multiple network interfaces 210 may be used to engage with various communications network types 213. For example, multiple network interfaces may be employed to allow for the communication over broadcast, multicast, and/or unicast networks.

Input Output interfaces (I/O) 208 may accept, communicate, and/or connect to user input devices 211, peripheral devices 212, cryptographic processor devices 228, and/or the like. I/O may employ connection protocols such as, but not limited to, audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 211 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 212 may be connected and/or communicate to I/O and/or other facilities of the like such as network interfaces, storage interfaces, directly to the interface bus, system bus, the CPU, and/or the like. Peripheral devices may be external, internal and/or part of controller 201. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating

It should be noted that although user input devices and peripheral devices may be employed, controller 201 may be embodied as an embedded, dedicated, and/or monitor-less (i.e., headless) device or system, wherein access would be provided over a network interface connection.

Cryptographic units such as, but not limited to, microcontrollers, processors 226, interfaces 227, and/or devices 228 may be attached, and/or communicate with the CCC controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 4o MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

Generally, any mechanization and/or embodiment allowing a processor to affect the storage and/or retrieval of information is regarded as memory 229. However, memory is a fungible technology and resource, thus, any number of memory embodiments may be employed in lieu of or in concert with one another. It is to be understood that controller 201 and/or a computer systemization may employ various forms of memory 229. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 229 will include ROM 206, RAM 205, and a storage device 214. A storage device 214 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

The memory 229 may contain a collection of program and/or database components and/or data such as, but not limited to: operating system component(s) 215 (operating system); information server component(s) 216 (information server); user interface component(s) 217 (user interface); Web browser component(s) 218 (Web browser); database(s) 219; mail server component(s) 221; mail client component(s) 222; cryptographic server component(s) 220 (cryptographic server); the CCC component(s) 235; and/or the like (i.e., collectively a component collection). These components may be stored and accessed from the storage devices and/or from storage devices accessible through an interface bus. Although non-conventional program components such as those in the component collection, typically, are stored in a local storage device 214, they may also be loaded and/or stored in memory such as: peripheral devices, RAM, remote storage facilities through a communications network, ROM, various forms of memory, 0 and/or the like.

The operating system component 215 is an executable program component facilitating the operation of controller 201. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NTNista/XP (Server), Palm OS, and/or the like. 23 An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow controller 201 to communicate with other entities through a communications network 213. Various communication0 protocols may be used by controller 201 as a subcarrier transport mechanism for1 interaction, such as, but not limited to: multicast, TCP/IP, UDP, unicast, and/or the like.

An information server component 216 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like.

The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on controller 201 based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with a database 219, operating systems, other program components, user interfaces, Web browsers, and/or the like.

Access to database 219 may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the CCC. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the CCC as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

An information server may contain, communicate, generate, obtain, and/or provide program component, system, user, and/or data communications, requests, and/or responses.

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XPNista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 217 is a stored program component that is executed by a CPU. The user interface may be a conventional graphic user interface as provided by, with, and/or atop operating systems and/or operating environments such as already discuss. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

A Web browser component 218 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the CCC-enabled nodes. The combined application may be nugatory on systems employing standard Web browsers.

A mail server component 221 is a stored program component that is executed by a CPU 203. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POPS), simple mail transfer protocol (SMTP), and/or the like. The mail server can route, forward, and process incoming and outgoing mail messages that have been sent, relayed and/or otherwise traversing through and/or to the CCC.

Access to the CCC mail may be achieved through a number of APIs offered by the individual Web server components and/or the operating system.

A mail server may contain, communicate, generate, obtain, and/or provide program component, system, user, and/or data communications, requests, information, and/or responses.

A mail client component 222 is a stored program component that is executed by a CPU 203. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP₃, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

A cryptographic server component 220 is a stored program component that is executed by a CPU 203, cryptographic processor 226, cryptographic processor interface 227, cryptographic processor device 228, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.5o9 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like.

Employing such encryption security protocols, the CCC may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the CCC component to engage in secure transactions if so desired. The cryptographic component facilitates the secure accessing of resources on the CCC and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

Database 219 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

In some embodiments, database 219 may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the CCC database is implemented as a data-structure, the use of database 219 may be integrated into another component such as the CCC component 235. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In some embodiments, database 219 includes several tables 219a-e. A Consumer table 219a includes fields such as, but not limited to: a Consumer ID, firstname, lastname, address, zipcode, worktype, bankinfo, budgetinfo, and/or the like. The consumer table may support and/or track multiple entity accounts on a CCC. A Contractor table 219b includes fields such as, but not limited to: Contractor ID, location, zipcodesserviced, worktype, projectdetails, projectpictures, specialties, bankinfo, bidssent, and/or the like. A Project table 219c includes fields such as, but not limited to: Project ID, location, zipcode, consumeridentity, contractoridentity, arbitratoridentity, bidssubmitted, bidaccepted, milestones, escrowaccount, paymentinfo, reviewinfo, and/or the like.

In some embodiments, database 219 may interact with other database systems. For example, employing a distributed database system, queries and data access by search CCC component may treat the combination of database 219, integrated data security layer database as a single database entity.

In some embodiments, user programs may contain various user interface primitives, which may serve to update the CCC. Also, various accounts may require custom database tables depending upon the environments and the types of clients the CCC may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 219a-c. The CCC may be configured to keep track of various settings, inputs, and parameters via database controllers.

Database 219 may communicate to and/or with other components in a component collection, including itself, and/or facilities of the like. Most frequently, database 219 communicates with the CCC component, other program components, and/or the like. Database 219 may contain, retain, and provide information regarding other nodes and data.

Component 235 is a stored program component that is executed by a CPU. In one embodiment, component 235 incorporates any and/or all combinations of the aspects of the CCC that was discussed in the previous figures. As such, the CCC affects accessing, obtaining and the provision of information, services, transactions, and/or the like across various communications networks. The features and embodiments of the CCC discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the CCC's features and facilities, and in many cases reduce the costs, energy consumption/requirements, and extend the life of CCC's underlying infrastructure; this has the added benefit of making the CCC more reliable. Similarly, many of the features and mechanisms are designed to be easier for users to use and access, thereby broadening the audience that may enjoy/employ and exploit the feature sets of the CCC; such ease of use also helps to increase the reliability of the CCC. In addition, the feature sets include heightened security as noted via the Cryptographic components 220, 226, 228 and throughout, making access to the features and data more reliable and secure.

The CCC may transform consumer project information, selected items, desired bids, milestones met, milestone payment request, accepted jobs, bid selection, and contractor information inputs via CCC various components into project payment outputs.

The CCC component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the CCC server employs a cryptographic server to encrypt and decrypt communications. The CCC component may communicate to and/or with other components in a component collection, including itself, and/or facilities of the like. Most frequently, the CCC component communicates with database 219, operating systems, other program components, and/or the like. The CCC may contain, communicate, generate, obtain, and/or provide program component, system, user, and/or data communications, requests, and/or responses.

The structure and/or operation of any of the CCC node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of controller 201 will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which II allow for grammar generation and parsing capabilities, which in turn may form the basis of communication messages within and between components.

For example, a grammar may be arranged to recognize the tokens of an HTTP post command (e.g.:w3c-post http:// . . . . Value 1) where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, controller 201 may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(‘Content-Type: text/plain’);
// set ip address and port to listen to for incoming data
$address=‘192.168.0.100’;
$port = 255;
// create a server-side SSL socket, listen for/accept incoming
communication
$sock = socketcreate(AFINET, SOCK STREAM, 0);
socket_bind($sock, $address, $port) or die(‘Could not bind to address’);
socket_listen($sock);
$client = socket_accept($sock);
// read input data from client device in 1024 byte blocks until end of
message
do {

$input =
$input = socket_read($client, 1024);
$data .= $input;

} while($input != ““);
// parse data to extract variables
$obj = json_decode($data, true);
// store input data in a database
mysql_connect(“201.408.185.132”,$DBserver,$password); // access
database server
mysqlselect(“CLIENTDB.SQL”); // select database to append
mysql_query(“INSERT INTO UserTable (transmission)
VALUES ($data)”); // add data to UserTable table in a CLIENT database
mysqlclose(“CLIENTDB.SQL”); // close connection to database
?>

Also, the following resources may be used to provide example embodiments regarding SOAP parser implementation:

http://www.xay.com/perl/site/lib/SOAP/Parser.html
http://publib.boulder.ibm.com/infocenter/tivihelp/v2r1/index.jsp?topic=/com.ibm.IBMDI.doc/referenceguide295.htm
and other parser implementations:
http://publib.boulder.ibm.com/infocenter/tivihelp/v2r1/index.jsp?topic=/com.ibm.IBMDI.doc/referenceguide259.htm
all of which are hereby expressly incorporated by reference.

In order to address various issues and advance the art, the entirety of this application shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a consumer, contractor or other individual, business or user of a CCC, database configuration and/or relational model, data type, data transmission and/or network framework, syntax structure, and/or the like, various embodiments of the CCC, may be implemented that enable a great deal of flexibility and customization. For example, aspects of the CCC may be adapted for any type of contract and payment projects. While various embodiments and discussions of the CCC have included contract matching and payment, however, it is to be understood that the embodiments described herein may be readily configured and/or customized for a wide variety of other applications and/or implementations.

What is claimed is:

1. A computer implemented method, comprising:
receiving, from a consumer at a processor, consumer project information corresponding to a consumer project;
retrieving contractor profiles;
determining, at the processor, at least one suggested contractor from the contractor profiles, wherein the at least one contractor has been prequalified by the CCC as capable of performing the consumer project and having obtained a performance bond in an amount commensurate with estimated value of the consumer project;
retrieving a bid from the at least one suggested contractor;
retrieving consumer feedback on the bid from the at least one suggested contractor, wherein the consumer feedback contains an accepted bid associated with one of the at least one suggested contractors;
obtaining funds from the consumer;
obtaining an indication of a milestone completion from a selected contractor;
obtaining a consumer acceptance that the milestone was properly completed; and
releasing a determined portion of the funds to the selected contractor.

2. The method of claim 1, wherein the consumer project information includes at least one of a project definition, a project payment schedule and a project budget.

3. The method of claim 1, wherein determining the at least one suggested contractor includes matching one or more consumer information of the consumer project information with one or more contractor information of the contractor profiles.

4. The method of claim 1, wherein a milestone includes at least one of the consumer project and one or more tasks comprising the consumer project.

5. The method of claim 1, wherein the indication includes receiving a payment request indicating completion by the selected contractor of one or more tasks of the consumer project.

6. The method of claim 1, further comprising receiving, from at least one of the consumer and the selected contractor, a change order defining a change to the consumer project.

7. The method of claim 6, wherein the change includes at least one of a removal of a task, an addition of a task, an increase in cost, and a reduction in cost.

8. The method of claim 7, further comprising obtaining a change order acceptance from at least one of the consumer and contractor.

9. The method of claim 8, further comprising updating the consumer project to include the change defined in the change order.

10. The method of claim 1, further comprising receiving from the consumer contact information for creating a contractor invitation.

11. The method of claim 1, further comprising sending to a display comparison information relating to a first bid and a second bid, wherein the comparison information includes one or more of a task and a cost associated with the consumer project.

12. A system comprising:
at least one programmable processor; and
a machine-readable medium storing instructions that, when executed by the at least one programmable processor, cause the at least one programmable processor to perform operations comprising:
receiving, from a consumer at a processor, consumer project information corresponding to a consumer project;
retrieving contractor profiles;
determining, at the processor, at least one suggested contractor from the contractor profiles, wherein the at least one contractor has been prequalified by the CCC as capable of performing the consumer project and having obtained a performance bond in an amount commensurate with estimated value of the consumer project;
retrieving a bid from the at least one suggested contractor;
retrieving consumer feedback on the bid from the at least one suggested contractor, wherein the consumer feedback contains an accepted bid associated with one of the at least one suggested contractors;
obtaining funds from the consumer;
obtaining an indication of a milestone completion from a selected contractor;
obtaining a consumer acceptance that the milestone was properly completed; and
releasing a determined portion of the funds to the selected contractor.

13. The system of claim 12, wherein the consumer project information includes at least one of a project definition, a project payment schedule and a project budget.

14. The system of claim 12, wherein determining the at least one suggested contractor includes matching one or more consumer information of the consumer project information with one or more contractor information of the contractor profiles.

15. The system of claim 12, wherein a milestone includes at least one of the consumer project and one or more tasks comprising the consumer project.

16. The system of claim 12, wherein the indication includes receiving a payment request indicating completion by the selected contractor of one or more tasks of the consumer project.

17. The system of claim 12, further comprising receiving, from at least one of the consumer and the selected contractor, a change order defining a change to the consumer project.

18. The system of claim 17, wherein the change includes at least one of a removal of a task, an addition of a task, an increase in cost, and a reduction in cost.

19. The system of claim 18, further comprising obtaining a change order acceptance from at least one of the consumer and contractor.

20. The system of claim 19, further comprising updating the consumer project to include the change defined in the change order.

21. The system of claim 12, further comprising receiving from the consumer contact information for creating a contractor invitation.

22. The system of claim 12, further comprising sending to a display comparison information relating to a first bid and a second bid, wherein the comparison information includes one or more of a task and a cost associated with the consumer project.
